(19) United States
(12) Patent Application Publication
(10) Pub. No.: US 2008/0194715 A1
(43) Pub. Date: Aug. 14, 2008

(54) Use of Copolymers Comprising Polyisobutene in Cosmetic Compositions

(75) Inventors: Volker Wendel, Frankfurt (DE); Darijo Mijolovic, Mannheim (DE); Matthias Kluglein, Ludwigshafen (DE); Hubertus Peter Bell, Mannheim (DE); Matthias Laubender, Schifferstadt (DE); Helmuth Vollmar, Ludwigshafen (DE); Anja Suckert, Mannheim (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 11/910,874

(22) PCT Filed: Apr. 7, 2006
(86) PCT No.: PCT/EP2006/061430

§ 371 Date: Oct. 5, 2007

(30) Foreign Application Priority Data
Apr. 8, 2005 (DE) 10 2005 016 537.0

(51) Int. Cl. C08J 9/16; B29C 47/00

(52) U.S. Cl. 521/56; 264/211.24; 264/211.12

(57) ABSTRACT

The present invention relates to the use of copolymers obtainable by copolymerization of at least one ethylenically unsaturated dicarboxylic acid anhydride derived from at least one dicarboxylic acid having 4 to 8 carbon atoms and at least one oligomer of branched or unbranched C₃-C₁₀-alkene, where at least one oligomer has an average molecular weight Mₙ in the range from 300 to 5000 g/mol, preferably up to 1200 g/mol or is obtainable by oligomerization of at least 3 equivalents of C₃-C₁₀-alkene, in cosmetic compositions.

The present invention relates to the use of
a) copolymers obtainable by copolymerization of
   (A) at least one ethylenically unsaturated dicarboxylic acid anhydride derived from at least one dicarboxylic acid having 4 to 8 carbon atoms,
   (B) at least one oligomer of branched or unbranched C₃-C₁₀-alkene, where at least one oligomer has an average molecular weight Mₙ in the range from 300 to 5000 g/mol, preferably up to 1200 g/mol or is obtainable by oligomerization of at least 3 equivalents of C₃-C₁₀-alkene,
   (C) optionally at least one α-olefin having up to 24, preferably having up to 16, carbon atoms
   (D) optionally at least one further ethylenically unsaturated comonomer different from (A), (B) and (C),
      if appropriate reaction with
   (E) at least one compound of the general formula Ia, Ib, Ic or Id

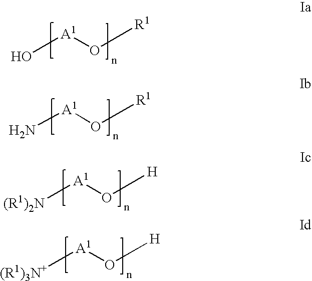

where
A¹ is C₂-C₂₀-alkylene, identical or different,
R¹ is C₁-C₃₀-alkyl, linear or branched, phenyl or hydrogen,
n is an integer from 1 to 200,
if appropriate subsequent contacting with water,
if appropriate mixed with
b) at least one oligomer of branched or unbranched C₃-C₁₀-alkene, where at least one oligomer has an average molecular weight Mₙ in the range from 300 to 5000 g/mol, preferably up to 1200 g/mol or is obtainable by oligomerization of at least 3 equivalents of C₃-C₁₀-alkene,
   in cosmetic compositions which are not chosen from the group consisting of washing, shower and bath preparations, compositions for the cleansing and/or care of the hair and photoprotective compositions with a sun protection factor (SPF) of at least 4.

In addition, the present invention relates to cosmetic compositions comprising a copolymer a), if appropriate mixed with an oligomer b) as defined herein, where the cosmetic compositions are not chosen from the group consisting of washing, shower and bath preparations, compositions for the cleansing and/or care of the hair and photoprotective compositions with a sun protective factor (SPF) of at least 4.

For the purposes of this invention, photoprotective compositions are understood as meaning compositions which comprise at least one, preferably two or more, UV filter substances. Such compositions which have a sun protection factor (SPF) of at least 4, measured in accordance with the COLIPA method, are not provided by this invention.

The use of numerous cosmetic compositions from the prior art on skin and hair leads to greasy, sometimes sticky films.

Preparations based on the fewest possible feed materials with good distributability and stability, good fatting effect coupled with good feel to the touch and feel on the skin, and low, preferably no, stickiness are desired.

Compositions based on the fewest possible feed materials are therefore inter alia of interest since in the case of prior art compositions, the large number of components required sometimes leads to skin irritations, allergic reactions or other incompatibilities.

Shiny areas of the skin which look greasy, particularly on the face, are regarded as being cosmetically undesirable. Such effects arise in particular where the sebum production of the glands in the skin is particularly strong, such as, for example, in the T zone of the human forehead. There is thus a need for improved compositions which allow excess oil or lipid to be removed from the surface of the skin and thus permit a balanced system, if appropriate have a matting effect and thus eliminate cosmetically undesired shine.

In addition, there is a need to improve compositions for removing dirt and pigment domains, such as, for example, make-up removal preparations.

### SOLUTION TO THE PROBLEM

The abovementioned aims are achieved through the use of
a) copolymers obtainable by copolymerization of
   (A) at least one ethylenically unsaturated dicarboxylic acid anhydride derived from at least one dicarboxylic acid having 4 to 8 carbon atoms,
   (B) at least one oligomer of branched or unbranched C₃-C₁₀-alkene, where at least one oligomer has an average molecular weight Mₙ in the range from 300 to 5000 g/mol, preferably up to 1200 g/mol or is obtainable by oligomerization of at least 3 equivalents of C₃-C₁₀-alkene,
   (C) optionally at least one α-olefin having up to 24, preferably having up to 16, carbon atoms
   (D) optionally at least one further ethylenically unsaturated comonomer different from (A), (B) and (C),
      if appropriate reaction with
   (E) at least one compound of the general formula Ia, Ib, Ic or Id

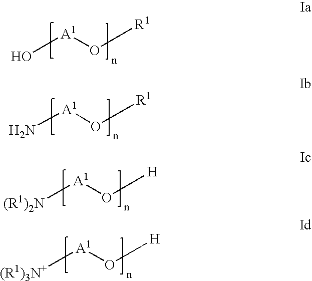

where
A¹ is C₂-C₂₀-alkylene, identical or different,
R¹ is C₁-C₃₀-alkyl, linear or branched, phenyl or hydrogen,
n is an integer from 1 to 200,
if appropriate subsequent contacting with water,
if appropriate mixed with
b) at least one oligomer of branched or unbranched C₃-C₁₀-alkene, where at least one oligomer has an average molecular weight Mₙ in the range from 300 to 5000 g/mol, preferably up to 1200 g/mol or is obtainable by oligomerization of at least 3 equivalents of C₃-C₁₀-alkene,
   in cosmetic compositions which are not chosen from the group consisting of washing, shower and bath preparations, shampoos, haircare compositions and photoprotective compositions with a sun protection factor (SPF) of at least 4.

### Copolymer a)

Copolymer a) is obtainable by preferably free-radical copolymerization of
(A) at least one ethylenically unsaturated dicarboxylic acid anhydride derived from at least one dicarboxylic acid having 4 to 8 carbon atoms, for example maleic anhydride, itaconic anhydride, citraconic anhydride, methylenemalonic anhydride, preferably itaconic anhydride, and maleic anhydride, and very particularly preferably maleic anhydride;
(B) at least one oligomer of branched or unbranched C₃-C₁₀-alkene, where at least one oligomer has an average molecular weight Mₙ in the range from 300 to 5000 g/mol, preferably up to 1200 g/mol or is obtainable by oligomerization of at least 3 equivalents of C₃-C₁₀-alkene,
(C) optionally at least one α-olefin having up to 24, preferably having up to 16, carbon atoms,
(D) optionally at least one further ethylenically unsaturated comonomer different from (A), (B) and (C),
   if appropriate reaction with
(E) at least one compound of the general formula Ia, Ib, Ic or Id

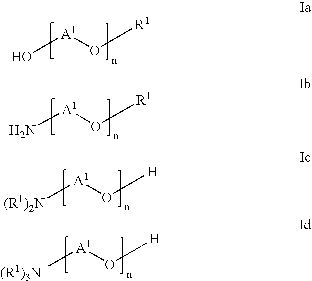

where
A¹ is C₂-C₂₀-alkylene, identical or different,
R¹ is C₁-C₃₀-alkyl, linear or branched, phenyl or hydrogen,
n is an integer from 1 to 200,
where the carboxyl groups of the copolymer a) can be at least partially esterified or amidated,
and if appropriate subsequent contacting with water.

### Oligomers (B) and b)

Suitable oligomers (B) and b) are oligomers of propylene and unbranched or preferably branched C₄-C₁₀-olefins, where at least one oligomer has an average molecular weight Mₙ in the range from 300 to 5000 g/mol, preferably up to 1200 g/mol or is obtainable by oligomerization of at least 3 equivalents of C₃-C₁₀-alkene.

By way of example, mention may be made of oligomers of propylene, isobutene, 1-pentene, 2-methylbutene-1,1-hexene, 2-methylpentene-1,2-methylhexene-1,2,4-dimethyl-1-hexene, diisobutene (mixture of 2,4,4-trimethyl-1-pentene and 2,4,4-trimethyl-2-pentene), 2-ethylpentene-1,2-ethylhexene-1 and 2-propylheptene-1,1-octene, 1-decene and 1-dodecene, very particular preference being given to oligomers of isobutene, diisobutene and 1-dodecene.

The oligomers (B) and b) have an ethylenically unsaturated group, which may be present in the form of a vinyl, vinylidene or alkylvinylidene group.

Co-oligomers of the abovementioned olefins with one another or with up to 20% by weight, based on (B) and b), of vinylaromatics, such as styrene and α-methylstyrene, C₁-C₄-alkylstyrene, such as, for example, 2-, 3- and 4-methylstyrene, and 4-tert-butylstyrene are also suitable.

Particularly preferred oligomers (B) and b) are oligopropylenes and oligoisobutenes with an average molecular weight Mₙ up to 1200 g/mol, preferably in the range from 300 to 1000 g/mol, particularly preferably of at least 400 g/mol, very particularly preferably of at least 500 g/mol, for example determined by means of gel permeation chromatography (GPC).

In one embodiment of the present invention, oligomers (B) and b) have a polydispersity M_{w}/Mₙ in the range from 1.1 to 10, preferably up to 5 and particularly preferably from 1.5 to 1.8.

In one embodiment of the present invention, oligomers (B) and b) have a bimodal molecular weight distribution with a maximum of Mₙ in the range from 500 to 1200 g/mol and a local maximum of Mₙ from 2000 to 5000 g/mol.

Oligomer (B) can be identical or different from oligomer (B). In one embodiment of the present invention, oligomer (B) and oligomer (b) are identical. Preferably suitable as oligomer b) are oligomers of C₄-olefins. In one embodiment of the invention, the oligomers b) are hydrogenated oligomers of C₄-olefins. Particularly preferred oligomers b) are also, if appropriate hydrogenated, oligomers comprising 3, 4, 5, 6, 7 or 8 C₄ olefin molecules.

Copolymer a) is present in the compositions according to the invention in an amount of from 0.1 to 15% by weight, preferably 1 to 10% by weight, particularly preferably 2 to 6% by weight, based on the weight of the composition. If copolymer is present mixed with oligomer b) in the composition, then the weight ratio of oligomer b) to copolymer a) in one embodiment of the invention is preferably from 1:10 to 3:1, particularly preferably from 1:5 to 2:1 and very particularly preferably from 1:2 to 1.5:1.

In one embodiment of the invention, the compositions according to the invention comprise copolymer a) and, in each case based on the composition, less than 1% by weight of, preferably less than 0.1% by weight of and in particular no oligomer b).

### Comonomer (C)

α-Olefins having up to 16 carbon atoms used as comonomer (C) are chosen from propylene, 1-butene, isobutene, 1-pentene, 4-methylbut-1-ene, 1-hexene, diisobutene (mixture of 2,4,4-trimethyl-1-pentene and 2,4,4-trimethyl-2-pentene), 1-heptene, 1-octene, 1-decene, 1-dodecene, 1-tetradecene and 1-hexadecene; particular preference is given to isobutene, diisobutene and 1-dodecene.

### Preparation of Copolymer a)

To prepare copolymer a) used according to the invention it is possible to copolymerize (A), (B) and, if appropriate, (C) with one another. To prepare copolymer a) according to the invention it is also possible to copolymerize (A), (B) and, if appropriate, (C) with one another and, if appropriate, to react with (E), or to copolymerize (A), (B) and, if appropriate, (C) and, if appropriate, a further comonomer (D) with one another, or it is possible to copolymerize (A) and (B) and, if appropriate (C) and, if appropriate, a further comonomer (D) with one another and, if appropriate, to react with (E).

If it is desired to use a copolymer a) whose carboxyl groups are at least partially esterified or amidated, then the compound (E) is at least one compound of the general formula Ia to Id, preferably Ia,

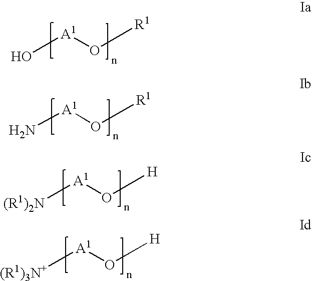

where the variables are defined as follows:
A¹ is C₂-C₂₀-alkylene, for example —(CH₂)₂—, —CH₂—CH(CH₃)—, —(CH₂)₃—, —CH₂—CH(C₂H₅)—, —(CH₂)₄—, —(CH₂)₅—, —(CH₂)₆—, preferably C₂-C₄-alkylene; in particular —(CH₂)₂—, —CH₂—CH(CH₃)— and —CH₂—CH(C₂H₅)—;
R¹ is phenyl,
   hydrogen
   or preferably C₁-C₃₀-alkyl, linear or branched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-hexadecyl, n-octadecyl, n-eicosyl; particularly preferably C₁-C₄-alkyl, such as methyl, ethyl, n-propyl, isopropyl, n-butyl, isobutyl, sec-butyl and tert-butyl, very particularly preferably methyl.
n is an integer in the range from 1 to 200, preferably 4 to 20.

The groups A¹ can of course only be different if n is a number greater than 1 or if different compounds of the general Ia to Id are used.

Particular examples of compounds of the general formula Ia are
methyl-terminally capped polyethylene glycols of the formula HO—(CH₂CH₂O)ₘ—CH₃ where m=1 to 200, preferably 4 to 100, particularly preferably 4-50
methyl-terminally capped block copolymers of ethylene oxide, propylene oxide and/or butylene oxide with a molecular weight Mₙ of from 300 to 5000 g/mol
methyl-terminally capped random copolymers of ethylene oxide, propylene oxide and/or butylene oxide with a molecular weight Mₙ of from 300 to 5000 g/mol
alkoxylated C₂- to C₃₀-alcohols, in particular fatty alcohol alkoxylates, oxo alcohol alkoxylates or Guerbet alcohol alkoxylates, where the alkoxylation can be carried out with ethylene oxide, propylene oxide and/or butylene oxide, examples being
C₁₃-C₁₅-oxo alcohol ethoxylates having 3 to 30 ethylene oxide units
C₁₃-oxo alcohol ethoxylates having 3 to 30 ethylene oxide units,
C₁₂-C₁₄-fatty alcohol ethoxylates having 3 to 30 ethylene oxide units,
C₁₀-oxo alcohol ethoxylates having 3 to 30 ethylene oxide units,
C₁₀-Guerbet alcohol ethoxylates having 3 to 30 ethylene oxide units,
C₉-C₁₁-oxo alcohol alkoxylates having 2 to 20 ethylene oxide units, 2 to 20 propylene oxide units and/or 1-5 butylene oxide units;
C₁₃-C₁₅-oxo alcohol alkoxylates having 2 to 20 ethylene oxide units, 2 to 20 propylene oxide units and/or 1-5 butylene oxide units;
C₄-C₂₀-alcohol ethoxylates having 2 to 20 ethylene oxide units. Preferred examples of compounds of the formula Ib are methyl-terminally capped polyethylene glycolamines of the formula H₂N—(CH₂CH₂O)ₘ—CH₃ where m=1 to 200, preferably 4 to 100, particularly preferably 4 to 50.

If it is desired to react with compound Id, then compound Ic can be reacted with alkylating agents such as, for example, halides or sulfates of the formula R¹—Y where Y is chosen from Cl, Br or I or (R¹)₂SO₄. Depending on the alkylating agent(s) used, compound Id with Y, SO₄²⁻ or R¹—SO₄⁻ is obtained as counterion.

In one embodiment of the present invention, mixtures of different components (E), for example of the formula Ia are used. In particular it is possible to use mixtures of compounds of the formula Ia in which—based in each case on the mixture—at least 95 mol %, preferably at least 98 mol % to at most 99.8 mol of R¹ is C₁-C₃₀-alkyl and at least 0.2 mol % and at most 5 mol %, preferably at most 2 mol %, is hydrogen.

In one embodiment of the present invention, to prepare the copolymer a) used according to the invention, the reaction mixture following the preferably free-radical copolymerization and, if appropriate, reaction with (E) is contacted with water, it being possible for the water to also comprise Brønsted acid or preferably Brønsted base. Examples of Brønsted acids are sulfuric acid, hydrochloric acid, tartaric acid and citric acid. Examples of Brønsted base are alkali metal hydroxide, such as, for example, NaOH and KOH, alkali metal carbonate, such as, for example, Na₂CO₃ and K₂CO₃, alkali metal hydrogencarbonate, such as, for example, NaHCO₃ and KHCO₃, ammonia, amines, such as, for example, trimethylamine, triethylamine, diethylamine, ethanolamine, N,N-diethanolamine, N,N,N-triethanolamine, N-methylethanolamine. In another embodiment of the present invention, it is even possible to contact with water during the preferably free-radical copolymerization.

### Monomers (D)

The monomer(s) (D) which can optionally be used for preparing copolymer (a) used according to the invention are different from (A), (B) and (C). Preferred monomers (D) are:

C₃-C₈-carboxylic acids and carboxylic acid derivatives of the general formula II

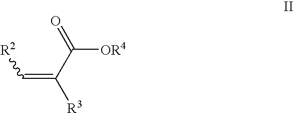

carboxamides of the formula III,

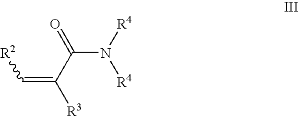

acyclic amides of the general formula IV a and cyclic amides of the general formula IV b

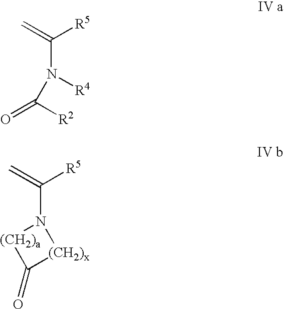

C₁-C₂₀-alkyl vinyl ethers, such as methyl vinyl ether, ethyl vinyl ether, n-propyl vinyl ether, isopropyl vinyl ether, n-butyl vinyl ether, isobutyl vinyl ether, 2-ethylhexyl vinyl ether or n-octadecyl vinyl ether;

N-vinyl derivatives of nitrogen-containing aromatic compounds, preferably N-vinylimidazole, 2-methyl-1-vinylimidazole, N-vinyloxazolidone, N-vinyltriazole, 2-vinylpyridine, 4-vinylpyridine, 4-vinylpyridine N-oxide, N-vinylimidazoline, N-vinyl-2-methylimidazoline,

α,β-unsaturated nitrites, such as, for example, acrylonitrile, methacrylonitrile; alkoxylated unsaturated ethers of the general formula V,

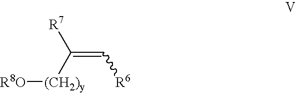

esters and amides of the general formula VI,

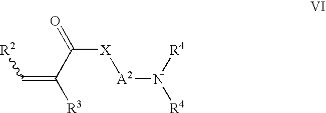

unsaturated esters of the general formula VII

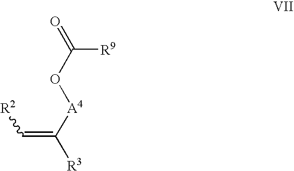

vinylaromatic compounds of the general formula VIII

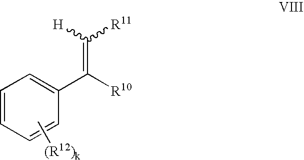

phosphate-, phosphonate-, sulfate-, and sulfonate-containing comonomers, such as, for example, [2-{(meth)acryloyloxy}ethyl]phosphate, 2-(meth)acrylamido-2-methyl-1-propanesulfonic acid;

α-olefins, linear or branched, having 18 to 40 carbon atoms, preferably having up to 24 carbon atoms, for example 1-octadecene, 1-eicosene, α-C₂₂H₄₄, α-C₂₄H₄₈ and mixtures of the abovementioned α-olefins.

Here, the variables are defined as follows:
R², R³ are identical or different and are chosen from unbranched or branched C₁-C₅-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, particularly preferably C₁-C₄-alkyl such as methyl, ethyl, n-propyl, isopropyl, n-butyl, isobutyl, sec-butyl and tert-butyl;
   and in particular hydrogen;
R⁴ is identical or different and is C₁-C₂₂-alkyl, branched or unbranched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-eicosyl; particularly preferably C₁-C₄-alkyl such as methyl, ethyl, n-propyl, isopropyl, n-butyl, isobutyl, sec-butyl and tert-butyl;
   or particularly preferably hydrogen;
R⁵ is hydrogen or methyl,
x is an integer in the range from 2 to 6, preferably 3 to 5;
y is an integer chosen from 0 or 1, preferably 1;
a is an integer in the range from 0 to 6, preferably in the range from 0 to 2;
R⁶, R⁷ are identical or different and are chosen from hydrogen, unbranched or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, preferably C₁-C₄-alkyl, such as methyl, ethyl, n-propyl, isopropyl, n-butyl, isobutyl, sec-butyl and tert-butyl, very particularly preferably methyl;
X is oxygen or N—R⁴;
R⁸ is [A³-O]ₙ—R⁴,
R⁹ is chosen from unbranched or branched C₁-C₂₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl, n-hexadecyl, n-octadecyl, n-eicosyl; preferably C₁-C₁₄-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl,
   and in particular hydrogen or methyl;
R¹⁰, R¹¹, independently of one another, are each hydrogen, methyl or ethyl, preferably R¹⁰ and R¹¹ are each hydrogen;
R¹² is methyl or ethyl;
k is an integer in the range from 0 to 2, preferably k=0,
A², A³ are identical or different and are C₂-C₂₀-alkylene, for example —(CH₂)₂—, —CH₂—CH(CH₃)—, —(CH₂)₃—, —CH₂—CH(C₂H₅)—, —(CH₂)₄—, —(CH₂)₅—, —(CH₂)₆—, preferably C₂-C₄-alkylene; in particular —(CH₂)₂—, —CH₂—CH(CH₃)— and —(CH₂)₃—;
A⁴ is C₁-C₂₀-alkylene, for example —CH₂—, —CH(CH₃)—, —CH(C₆H₅)—, —C(CH₃)₂—, —(CH₂)₂—, —CH₂—CH(CH₃)—, —(CH₂)₃—, —CH₂—CH(C₂H₅)—, —(CH₂)₄—, —(CH₂)₅—, —(CH₂)₆—, preferably C₂-C₄-alkylene; in particular —(CH₂)₂—, —CH₂—CH(CH₃)— and —(CH₂)₃—,
   or in particular a single bond.

The other variables are as defined above.

Compounds of the formula III chosen by way of example are (meth)acrylamides, such as acrylamide, N-methylacrylamide, N,N-dimethylacrylamide, N-ethylacrylamide, N-propylacrylamide, N-tert-butylacrylamide, N-tert-octylacrylamide, N-undecyl-acrylamide or the corresponding methacrylamides.

Compounds of the formula IV a chosen by way of example are N-vinylcarboxamides, such as N-vinylformamide, N-vinyl-N-methylformamide, N-vinylacetamide or N-vinyl-N-methylacetamide; representatives of compounds of the formula IV b chosen by way of example are N-vinylpyrrolidone, N-vinyl-4-piperidone and N-vinyl-ε-caprolactam.

Compounds of the formula VI chosen by way of example are (meth)acrylic esters and amides, such as N,N-dialkylaminoalkyl(meth)acrylates or N,N-dialkylaminoalkyl(meth)-acrylamides; examples are N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethyl-aminopropyl acrylate, N,N-diethylaminopropyl methacrylate, 2-(N,N-dimethylamino)-ethylacrylamide, 2-(N,N-dimethylamino)ethylmethacrylamide, 2-(N,N-diethylamino)-ethylacrylamide, 2-(N,N-diethylamino)ethylmethacrylamide, 3-(N,N-dimethylamino)-propylacrylamide and 3-(N,N-dimethylamino)propylmethacrylamide.

Compounds of the formula VII chosen by way of example are vinyl acetate, allyl acetate, vinyl propionate, vinyl butyrate, vinyl-2-ethylhexanoate or vinyl laurate.

Vinylaromatic compounds of the general formula VIII chosen by way of example are α-methylstyrene, para-methylstyrene and in particular styrene.

As comonomer (D), very particular preference is given to using: acrylic acid, 1-octa-decene, methacrylic acid, methyl acrylate, methyl methacrylate, acrylamide, vinyl n-butyl ether, vinyl isobutyl ether, styrene, N-vinylformamide, N-vinylpyrrolidone, 1-vinylimidazole and 4-vinylpyridine.

With regard to (A), (B), if appropriate (C) and if appropriate (D), the copolymers a) can be block copolymers, alternating copolymers or random copolymers, preference being given to alternating copolymers.

In one embodiment of the present invention, the anhydride groups of copolymer a) following the polymerization are present in completely or partially hydrolyzed form and, if appropriate, in neutralized form.

In one embodiment of the present invention, the anhydride groups of copolymer a) following the copolymerization are in the form of anhydride groups.

In one embodiment of the present invention, the molar ratios in copolymer a) used according to the invention are as follows:
(A) is in the range from 5 to 60 mol %, preferably 10 to 55 mol %,
(B) is in the range from 1 to 95 mol %, preferably 5 to 70 mol %,
(C) is in the range from 0 to 60 mol %, preferably 10 to 55 mol %,
(D) 0 to 70 mol %, preferably 1 to 50 mol %, in each case based on copolymer, where the sum of (A), (B), (C) and (D) gives 100 mol %, and
(A) is in the range from 0 to 50 mol %, preferably 1 to 30 mol %, particularly preferably 2 to 20 mol %, based on all carboxyl groups of the copolymer.

In one embodiment, a weight ratio of oligomer b) to copolymer a) in the range from 0.1:1 to 100:1, preferably from 0.5:1 to 0:1, is chosen.

In another embodiment, a weight ratio of oligomer (b) to copolymer a) in the range from 1:1 to 100:1, preferably from 10:1 to 50:1, is chosen.

The copolymers a) used according to the invention and mixtures thereof with oligomer b) and their preparation are described in the German patent applications with the file references DE 16353557.8, DE 10355402.5 and DE 10345094.7, which are hereby incorporated by reference in their entirety.

In one embodiment of the present invention, the copolymers a) of (A), (B) and, if appropriate, (C) and (D) used according to the invention have an average molar mass M_{w} in the range from 1000 g/mol to 50 000 g/mol, preferably 1500 g/mol to 25 000 g/mol, determined, for example, by gel permeation chromatography with dimethylacetamide as solvent and polymethyl methacrylate as standard.

Copolymers a) of (A), (B) and, if appropriate, (C) and (D) and (E) used according to the invention can, with regard to (A), (B) and, if appropriate, (C) and (D), be block copolymers, alternating copolymers or random copolymers, preference being given to alternating copolymers.

The polydispersity M_{w}/Mₙ of copolymers of (A), (B) and, if appropriate, (C) and (D) and (E) used as copolymer a) is generally in the range from 1:1 to 20, preferably from 2 to 10.

In one embodiment of the present invention, copolymers of (A), (B) and, if appropriate, (C) and (D) and (E) used according to the invention as copolymer a) have K values in accordance with Fikentscher in the range from 5 to 100, preferably 8 to 30 (measured in accordance with H. Fikentscher at 25° C. in cyclohexanone and at a polymer concentration of 2% by weight).

In one embodiment of the present invention, copolymers a) used according to the invention can comprise non-copolymerized comonomer (B), for example in fractions of from 1 to 50% by weight, based on the total weight of copolymer a).

To prepare copolymers of (A), (B) and, if appropriate, (C) and (D) and (E) used according to the invention as copolymer a), the starting materials are (A), (B) and, if appropriate, (C) and (D), which are preferably free-radically copolymerized with one another and, if appropriate, reacted with (E). The reaction with (E), if desired, can take place before, during and after the copolymerization. Contact with water can take place during or preferably after the copolymerization. However, to prepare copolymer a) used according to the invention it is also possible to dispense with contacting with water.

In a specific embodiment of the present invention, a free-radical copolymerization of (A), (B) and, if appropriate, (C) and (D) is firstly carried out, followed by reaction with (E).

In another specific embodiment of the present invention, the free-radical copolymerization of (A), (B), and, if appropriate, (C) and (D) is carried out in the presence of all or some of the compound (E) to be used.

In another specific embodiment of the present invention, (A) and, if appropriate, (D) are firstly reacted with (E) and then copolymerized free-radically with (B) and, if appropriate, (C).

If a reaction of copolymer of (A), (B) and, if appropriate, (C) and (D) with (E) or a free-radical polymerization in the presence of (E) is desired, then the total amount of (E) is calculated so that the starting point is a complete reaction of (E) and up to 50 mol %, preferably 1 to 30 mol %, preferably 2 to 20 mol %, of (E), based on all carboxyl groups of the copolymer, is used. For the purposes of the present invention, the term “all carboxyl groups present in the polymer” is understood as meaning those carboxyl groups from copolymerized comonomers (A) and, if appropriate, (D) which are present as anhydride, as C₁-C₄-alkyl ester or as carboxylic acid.

The free-radical copolymerization is advantageously started via initiators, for example peroxides or hydroperoxides. Peroxides and hydroperoxides which may be mentioned by way of example are di-tert-butyl peroxide, tert-butyl peroctoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide, dicyclohexyl peroxide dicarbonate. The use of redox initiators is also suitable, for example combinations of hydrogen peroxide or sodium peroxodisulfate or one of the abovementioned peroxides with a reducing agent. Suitable reducing agents are, for example: ascorbic acid, tartaric acid, Fe(II) salts, such as, for example, FeSO₄, sodium bisulfite, potassium bisulfite.

Suitable initiators are also azo compounds, such as 2,2′-azobis(isobutyronitrile), 2,2′-azobis(2-methylpropionamidine) dihydrochloride and 2,2′-azobis(4-methoxy-2,4-dimethylvaleronitrile).

In general, initiator is used in amounts of from 0.1 to 20% by weight, preferably 0.2 to 15% by weight, calculated on the basis of the mass of all comonomers.

The copolymerization can be carried out in the presence or in the absence of solvents and precipitation agents. Suitable solvents for the free-radical copolymerization are polar solvents which are inert toward acid anhydride, such as, for example, acetone, tetrahydrofuran and dioxane. Suitable precipitating agents are, for example, toluene, ortho-xylene, meta-xylene and aliphatic hydrocarbons.

In a preferred embodiment the process is carried out without solvents or in the presence of only small amounts of solvents, i.e. 0.1 to at most 10% by weight, based on the total mass of comonomers (A), (B) and, if appropriate, (C) and (D). Solvents are understood as meaning substances which are inert under the conditions of the copolymerization and the esterification or amide formation, in particular aliphatic and aromatic hydrocarbons, such as, for example, cyclohexane, n-heptane, isododecane, benzene, toluene, ethylbenzene, xylene as isomer mixture, meta-xylene, ortho-xylene. If the reaction with (E) is carried out without acidic catalyst or if the reaction with (E) is dispensed with, then the free-radical copolymerization and, if appropriate, reaction with (E) can also be carried out in solvents chosen from ketones, such as, for example, acetone, methyl ethyl ketone, or cyclic or acyclic ethers, such as, for example, tetrahydrofuran or di-n-butyl ether.

The copolymerization and, if appropriate, the reaction with (E) is preferably carried out with the exclusion of oxygen, for example in a nitrogen or argon atmosphere, preferably in a stream of nitrogen.

For the free-radical copolymerization and, if appropriate, the reaction with (E), customary apparatuses can be used, e.g. autoclaves and reactors.

The order of the addition of the comonomers can be undertaken in various ways.

In one embodiment, a mixture of (E) and (A) is initially introduced, and initiator and simultaneously (B) and, if appropriate, (C) and (D) are added. Here, it is preferred to add (B) and, if appropriate, (C) and, if appropriate, (D) in the manner of a feed process.

In another embodiment, a mixture of (E) and (A) is initially introduced, and initiator and simultaneously (B) and, if appropriate, (C) and (D) are added in the manner of a feed process, where initiator (B) and, if appropriate, (C) and (D) are in each case dissolved in (E).

In another embodiment, a mixture of (E) and (A) is initially introduced, and initiator and (B), (C) and (D) are added in the manner of a feed process, the feed rates of (B), (C) and (D) being chosen to be different.

In another embodiment, a mixture of (E) and (A) is initially introduced, and initiator and (B), (C) and (D) in the manner of a feed process are added, the feed rates of (B), (C) and (D) being chosen to be same.

In another embodiment, (A) and, if appropriate, (D) are initially introduced, and initiator and (B) and, if appropriate, (C) are added in the manner of a feed process and then, if appropriate, reacted with (E).

In another embodiment, (A) is initially introduced, and initiator, (B) and, if appropriate, (C) and (D) are added in the manner of a feed process and then, if appropriate, reacted with (E).

In another embodiment, (A) and (B) are initially introduced, and initiator and, if appropriate, (C) are added in the manner of a feed process and then, if appropriate, reacted with (E).

In another embodiment, (B) and, if appropriate, (C) and (D) are initially introduced, and initiator and (A) are added in the manner of a feed process and then, if appropriate, reacted with (E).

In another embodiment, (B) and, if appropriate, (C) are initially introduced, and initiator (A) and, if appropriate, (D) are added in the manner of a feed process and then, if appropriate, reacted with (E).

In another embodiment, (B) and, if appropriate, (D) are initially introduced, and initiator (A) and, if appropriate, (C) are added in the manner of a feed process and then, if appropriate, reacted with (E).

In another embodiment, (A), (B) and, if appropriate, (C) and (E) are initially introduced, and initiator and (D) are added in the manner of a feed process. (A), (B) and, if appropriate, (E) can also be initially introduced in a solvent.

In one embodiment, further initiator is added during the addition of (B), (C) and, if appropriate, (D).

In one embodiment, further initiator is added during the addition of (A) and, if appropriate, (D).

In one embodiment, the temperature for the copolymerization of (A), (B) and, if appropriate, (C) and (D) is in the range from 80 to 300° C., preferably 90 to 200° C.

The pressure is, for example, in the range from 1 to 15 bar, preferably 1 to 10 bar.

It is possible to use regulators, for example C₁ to C₄-aldehydes, formic acid and organic compounds comprising SH groups, such as 2-mercaptoethanol, 2-mercaptopropanol, mercaptoacetic acid, tert-butyl mercaptan, n-dodecyl mercaptan. Polymerization regulators are generally used in amounts of from 0.1 to 10% by weight, based on the total mass of the comonomers used. Preference is given to working without the use of regulators.

During the copolymerization it is possible to add one or more polymerization inhibitors in small amounts, for example hydroquinone monomethyl ether. Polymerization inhibitor can be advantageously metered in with (B) and, if appropriate, (C) and (D). Suitable amounts of polymerization inhibitor are 0.01 to 1% by weight, preferably 0.05 to 0.5% by weight, calculated on the mass of all comonomers. The addition of polymerization inhibitor is particularly preferred if the copolymerization is carried out at temperatures above 80° C.

When the addition of (A), (B) and, if appropriate, (C) and (D) is complete, if appropriate (E) and, if appropriate, initiator can be left to after-react.

The duration of the free-radical copolymerization is generally 1 to 12 hours, preferably 2 to 9 hours, particularly preferably 3 to 6 hours.

The duration of the reaction with (E) can be 1 to 12 hours, preferably 2 to 9 hours, particularly preferably 3 to 6 hours.

If the preparation of (a) is carried out such that (A), (B) and, if appropriate, (C) and (D) are copolymerized in the presence of the total amount of (E), then a reaction time of, in total, 1 to 12 hours, preferably 2 to 10 hours is suitable, particularly preferably 3 to 8.

The reaction with (E) can be carried out in the absence or presence of catalysts, in particular acidic catalysts, such as, for example, sulfuric acid, methanesulfonic acid, p-toluenesulfonic acid, n-dodecylbenzenesulfonic acid, hydrochloric acid or acidic ion exchangers.

In a further variant of the process described, the reaction with (E) is carried out in the presence of an entrainer, which forms an azeotrope with water which forms, if appropriate, during the reaction.

In general, under the conditions of the above-described steps (E) reacts completely or to a certain percentage with the carboxyl groups of the anhydrides (A) and, if appropriate, the carboxyl groups from (D). In general, less than 40 mol % remain as unreacted (E).

It is possible, through methods known per se, such as, for example, extraction, to separate off unreacted (E) from the copolymer obtainable by the preparation process according to the invention.

In another embodiment, the further step of separating off unreacted (E) from the prepared copolymer can be dispensed with. In this embodiment, copolymers are used together with a certain percentage of unreacted (E) for the treatment of fibrous substrates.

The above-described copolymerization of (A), (B) and, if appropriate, (C) and (D) gives copolymers. The copolymers which form can be subjected to purification by conventional methods, for example reprecipitation or extractive removal of unreacted monomers. If a solvent or precipitation agent has been used, then it is possible to remove this once copolymerization is complete, for example by distillation.

Within the scope of the present invention, copolymer prepared as described above can be brought into contact with water, the amount of added water being calculated such that the dispersion according to the invention which are obtained have a water content in the range from 30 to 99.5% by weight, based on the total mass of auxiliaries.

In one embodiment, following the free-radical copolymerization and, if appropriate, the reaction with (E), water is added, it being possible for the water to also comprise a Brønsted acid or, preferably, Brønsted base. Examples of Brønsted acids are sulfuric acid, hydrochloric acid, tartaric acid and citric acid. Examples of Brønsted base are alkali metal hydroxide, such as, for example, NaOH and KOH, alkali metal carbonate, such as, for example, Na₂CO₃ and K₂CO₃, alkali metal hydrogencarbonate, such as, for example, NaHCO₃ and KHCO₃, ammonia, amines, such as, for example, trimethyl-amine, triethylamine, diethylamine, ethanolamine, N,N-diethanolamine, N,N,N-triethanolamine, N-methylethanolamine. The concentration of Brønsted acid or, preferably, Brønsted base is generally 1 to 20% by weight, based on the sum of water and Brønsted acid or water and Brønsted base.

It is possible to add water during the free-radical copolymerization, although water is preferably added only toward the end of the free-radical copolymerization. If the free-radical copolymerization and the reaction with (E) has been carried out in the presence of solvent, then it is preferred to firstly remove solvent, for example by distillation, and only then to contact with water.

Contacting with water, which can, if appropriate, comprise Brønsted acid, or, preferably, Brønsted base, results in the carboxylic acid anhydride groups present in the copolymer being partially or completely hydrolyzed.

After contacting with water, which can, if appropriate, comprise Brønsted acid or, preferably, Brønsted base, the mixture can be left to after-react at temperatures in the range from 20 to 120° C., preferably up to 100° C., for a period of from 10 minutes to 48 hours.

In one embodiment of the present invention, water, which can also comprise Brønsted acid or, preferably Brønsted base, is initially introduced at 50 to 100° C., and copolymer heated, if appropriate, to 50 to 120° C. is added in the manner of a feed process.

In a further embodiment of the present invention, copolymer is initially introduced at 50 to 120° C. and, in the manner of a feed process, the water heated, if appropriate, to 50 to 100° C., where the water can also comprise Brønsted acid or preferably Brønsted base, is added.

In one embodiment of the present invention, a mixture of water, where the water can also comprise Brønsted acid or preferably Brønsted base and nonionic surfactant, is initially introduced at 50 to 100° C., and copolymer heated, if appropriate, to 50 to 120° C. is added in the manner of a feed process. Suitable nonionic surfactants are, for example, polyalkoxylated, preferably 3 to 30-fold alkoxylated, C₁₂-C₃₀-alkanols.

In a further embodiment, copolymer is initially introduced at 50 to 120° C. and, in the manner of a feed process, the mixture of water heated, if appropriate, to 50 to 100° C. is added, where the water can also comprise Brønsted acid or preferably Brønsted base and nonionic surfactant. Suitable nonionic surfactant is, for example, polyalkoxylated, preferably 3 to 30-fold alkoxylated, C₁₂-C₃₀-alkanol.

The copolymers described above are usually produced in the form of aqueous dispersions or aqueous solutions or in bulk. Aqueous dispersions and solutions of copolymers described above are likewise provided by the present invention. From aqueous dispersions and solutions according to the invention it is possible to isolate copolymers according to the invention via methods known per se to the person skilled in the art, for example by evaporation of water or by spray-drying.

### Cosmetic Compositions

The cosmetic compositions according to the invention comprising copolymer a) and, if appropriate, oligomer b) can be in the form of aqueous or aqueous-alcoholic solutions, O/W and W/O emulsions, hydrodispersion formulations, solids-stabilized formulations, stick formulations, PIT formulations, in the form of creams, foams, sprays (pump spray or aerosol), gels, gel sprays, lotions, oils, oil gels or mousse and be formulated correspondingly with customary further auxiliaries.

Preferred cosmetic compositions for the purposes of the present invention are gel creams, hydroformulations, stick formulations, cosmetic oils and oil gels, mascara, self-tanning agents, facecare compositions, bodycare compositions, aftersun preparations, hair-shaping compositions, hair-setting compositions and compositions for decorative cosmetics.

Besides copolymer a) and, if appropriate, oligomer b), the cosmetic compositions can also comprise cosmetically acceptable additives customary in such formulations, such as emulsifiers and coemulsifiers, solvents, surfactants, oil bodies, preservatives, perfume oils, cosmetic care substances and active ingredients, such as AHA acids, fruit acids, ceramides, phytantriol, collagen, vitamins and provitamins, for example vitamin A, E and C, retinol, bisabolol, panthenol, natural and synthetic photoprotective agents, natural substances, opacifiers, solubility promoters, repellents, bleaches, colorants, tinting agents, tanning agents (e.g. dihydroxyacetone), micropigments, such as titanium dioxide or zinc oxide, superfatting agents, pearlescent waxes, consistency regulators, thickeners, solubilizers, complexing agents, fats, waxes, silicone compounds, hydrotropes, dyes, stabilizers, pH regulators, reflectors, proteins and protein hydrolyzates (e.g. wheat, almond or pea proteins), ceramide, protein hydrolyzates, salts, gel formers, consistency regulators, silicones, humectants (e.g. 1,2-pentanediol), refatting agents and further customary additives. Furthermore, to establish the properties desired in each case, further polymers in particular may also be present.

It is also advantageous to provide the compositions according to the invention in a liquid form such that wipes of various materials and embossing can be impregnated with them. The person skilled in the art knows how to prepare wipes impregnated in this way.

To protect against adverse effects as a result of UV radiation, UV photoprotective agents may also be present in the cosmetic compositions, although the sun protection factor (SPF) of the compositions, determined in accordance with the COLIPA method, is less than 4.

Compositions with an SPF of less than 4 are not provided by this invention.

In one embodiment of the invention, the cosmetic compositions according to the invention comprise, besides copolymer a), which is present, if appropriate, mixed with oligomer b), also at least one oil and/or fat phase.

### Skin Cosmetic Preparations

Examples of cosmetic preparations according to the invention are skin cosmetic preparations, in particular those for caring for the skin. These are present, in particular, as W/O or O/w skin creams, day and night creams, eye creams, face creams, antiwrinkle creams, mimic creams, moisturizing creams, bleaching creams, vitamin creams, skin lotions, care lotions and moisturizing lotions.

They are also suitable for skin cosmetic preparations such as face toners, face masks, deodorants and other cosmetic lotions and for use in decorative cosmetics, for example as concealing stick, stage make-up, in mascara and eye shadows, lipsticks, kohl pencils, eyeliners, makeup, foundations, blushers and powders and eyebrow pencils.

Furthermore, the compositions according to the invention can be used in nose strips for pore cleansing, in anti-acne compositions, repellents, shaving compositions, hair-removal compositions, intimate care compositions, footcare compositions, and in babycare.

Besides copolymer a), if appropriate oligomer b) and suitable carriers, the skin cosmetic preparations according to the invention can also comprise further active ingredients and auxiliaries customary in skin cosmetics and as described above and below. These include preferably emulsifiers, preservatives, perfume oils, cosmetic active ingredients, such as phytantriol, vitamin A, E and C, retinol, bisabolol, panthenol, natural and synthetic photoprotective agents, bleaching agents, colorants, tinting agents, tanning agents, collagen, protein hydrolyzates, stabilizers, pH regulators, dyes, salts, thickeners, gel formers, consistency regulators, silicones, humectants, conditioning agents, refatting agents and further customary additives.

Conventional polymers can also be added to the compositions according to the invention if specific properties are to be set. To establish certain properties, such as, for example, improving the feel to the touch, the spreading behavior, the water resistance and/or the binding of active substances and auxiliaries, such as pigments, the compositions can additionally also comprise conditioning substances based on silicone compounds. Suitable silicone compounds are, for example, polyalkylsiloxanes, polyarylsiloxanes, polyarylalkylsiloxanes, polyether siloxanes or silicone resins. In one embodiment of the invention, the compositions according to the invention comprise no further conditioning polymers since copolymer a), if appropriate mixed with oligomer b), already has a good conditioning effect.

Further possible ingredients of the compositions according to the invention are described below under the respective keyword.

### Hair Cosmetic Preparations

Hair cosmetic compositions according to the invention are neutralizing compositions for permanent waves, curl relaxers, styling wrap lotions, hair-setting compositions which are not in the form of a shampoo, hair-shaping compositions and hair colorants.

A preferred used is the use of copolymer a), if appropriate mixed with oligomer b), in hair styling setting compositions which are in the form of sprays or hair foams.

Besides copolymer a) and, if appropriate, oligomer b), a water-containing standard hair spray formulation has, for example, also 2 to 10% by weight of a setting polymer, ethanol, water and dimethyl ether and/or propane/n-butane and/or propane/isobutane.

Ingredients of cosmetic compositions according to the invention

### Oils, Fats and Waxes

In addition to the oligomer b) which is present if appropriate, the skin and hair cosmetic compositions according to the invention preferably comprise further oils, fats or waxes.

A particular advantage of the present invention is that when using copolymer a), which is present mixed with oligomer b), the required amount of further oils, fats or waxes can be considerably less than is customary in the prior art although the application properties are at least as good.

Constituents of the oil and/or fat phase of the composition according to the invention are advantageously chosen from the group of lecithins and fatty acid triglycerides, namely the triglycerol esters of saturated and/or unsaturated, branched and/or unbranched alkanecarboxylic acids with a chain length of from 8 to 24, in particular 12 to 18, carbon atoms. The fatty acid triglycerides can, for example, be chosen advantageously from the group of synthetic, semisynthetic and natural oils, such as, for example, olive oil, sunflower oil, soybean oil, peanut oil, rapeseed oil, almond oil, palm oil, coconut oil, castor oil, wheat germ oil, grapeseed oil, thistle oil, evening primrose oil, macadamia nut oil and the like. Further polar oil components can be chosen from the group of esters of saturated and/or unsaturated, branched and/or unbranched alkanecarboxylic acids with a chain length of from 3 to 30 carbon atoms and saturated and/or unsaturated, branched and/or unbranched alcohols with a chain length of from 3 to 30 carbon atoms, and also from the group of esters of aromatic carboxylic acids and saturated and/or unsaturated, branched and/or unbranched alcohols with a chain length of from 3 to 30 carbon atoms. Such ester oils can then advantageously be chosen from the group consisting of isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexyldecyl stearate, 2-octyldodecyl palmitate, oleyl oleate, oleyl erucate, erucyl oleate, erucyl erucate, dicaprylyl carbonate (cetiol CC) and cocoglycerides (Myritol 331), butylene glycol dicaprylate/dicaprate and dibutyl adipate, and synthetic, semisynthetic and natural mixtures of such esters, such as, for example, jojoba oil.

In addition, one or more oil components can be chosen advantageously from the group of branched and unbranched hydrocarbons and hydrocarbon waxes, silicone oils, dialkyl ethers, the group of saturated or unsaturated, branched or unbranched alcohols.

Any mixtures of such oil and wax components can also be used advantageously for the purposes of the present invention. It may also, if appropriate, be advantageous to use waxes, for example cetyl palmitate, as the sole lipid component of the oil phase.

According to the invention, the oil component is chosen advantageously from the group consisting of 2-ethylhexyl isostearate, octyldodecanol, isotridecyl isononanoate, isoeicosane, 2-ethylhexyl cocoate, C12-15-alkyl benzoate, caprylic/capric triglyceride, dicaprylyl ether.

Of advantage according to the invention are mixtures of C12-15-alkyl benzoate and 2-ethylhexyl isostearate, mixtures of C12-15-alkyl benzoate and isotridecyl isononanoate, and mixtures of C12-15-alkyl benzoate, 2-ethylhexyl isostearate and isotridecyl isononanoate.

According to the invention, as oils with a polarity of from 5 to 50 mN/m, particular preference is given to using fatty acid triglycerides, in particular soybean oil and/or almond oil.

Of the hydrocarbons, paraffin oil, squalane, squalene and in particular (optionally hydrogenated) polyisobutenes are to be used for the purposes of the present invention.

In addition, the oil phase can be chosen advantageously from the group of Guerbet alcohols. Guerbet alcohols are named after Marcel Guerbet, who described their preparation for the first time. They are formed in accordance with the reaction equation

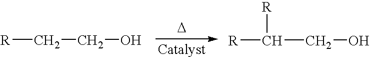

by oxidation of an alcohol to an aldehyde, by aldol condensation of the aldehyde, elimination of water from the aldol and hydrogenation of the allyl aldehyde. Guerbet alcohols are even liquid at low temperatures and bring about virtually no skin irritations. They can be used advantageously as fatty, superfatting and also refatting constituents in cosmetic compositions.

The use of Guerbet alcohols in cosmetics is known per se. Such species are then characterized in most cases by the structure

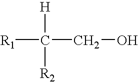

Here, R₁ and R₂ are generally unbranched alkyl radicals.

According to the invention, the Guerbet alcohol(s) is/are advantageously chosen from the group where

R₁=propyl, butyl, pentyl, hexyl, heptyl or octyl and
R₂=hexyl, heptyl, octyl, nonyl, decyl, undecyl, dodecyl, tridecyl or tetradecyl.

Guerbet alcohols preferred according to the invention are 2-butyloctanol (commercially available, for example, as Isofol®12 (Condea)) and 2-hexyldecanol (commercially available, for example, as Isofol®16 (Condea)).

Mixtures of Guerbet alcohols according to the invention are also to be used advantageously according to the invention, such as, for example, mixtures of 2-butyl-octanol and 2-hexyldecanol (commercially available, for example, as Isofol®14 (Condea)).

Any mixtures of such oil and wax components are also to be used advantageously for the purposes of the present invention. Among the polyolefins, polydecenes are the preferred substances.

The oil component can advantageously also have a content of cyclic or linear silicone oils or consist entirely of such oils, although it is preferred to use an additional content of other oil phase components apart from the silicone oil or the silicone oils.

Low molecular weight silicones or silicone oils are generally defined by the following general formula

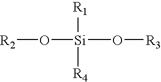

Higher molecular weight silicones or silicone oils are generally defined by the following general formula

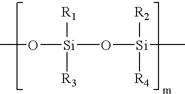

where the silicon atoms may be substituted by identical or different alkyl radicals and/or aryl radicals, which are depicted here in general terms by the radicals R₁ to R₄. The number of different radicals is not, however, necessarily limited to 4. m can assume values from 2 to 200 000. Cyclic silicones to be used advantageously according to the invention are generally defined by the following general formula

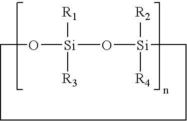

where the silicon atoms can be substituted by identical or different alkyl radicals and/or aryl radicals, which are depicted here in general terms by the radicals R₁ to R₄. The number of different radicals is, however, not necessarily limited to 4. n here can assume values from 3/2 to 20. Fractional values for n take into account that uneven numbers of siloxyl groups may be present in the cycle.

Phenyltrimethicone is advantageously chosen as silicone oil. Other silicone oils, for example dimethicone, hexamethylcyclotrisiloxane, phenyldimethicone, cyclomethicone (e.g. decamethylcyclopentasiloxane), hexamethylcyclotrisiloxane, polydimethylsiloxane, poly(methylphenylsiloxane), cetyldimethicone, behenoxydimethicone are also to be used advantageously for the purposes of the present invention. Also advantageous are mixtures of cyclomethicone and isotridecyl isononanoate, and those of cyclomethicone and 2-ethylhexyl isostearate.

It is, however, also advantageous to choose silicone oils of similar constitution to the compounds described above whose organic side chains are derivatized, for example polyethoxylated and/or polypropoxylated. These include, for example, polysiloxane polyalkyl-polyether copolymers, such as, for example, cetyldimethicone copolyol.

Cyclomethicone (octamethylcyclotetrasiloxane) is used advantageously as silicone oil to be used according to the invention.

Fat and/or wax components to be used advantageously according to the invention can be chosen from the group of vegetable waxes, animal waxes, mineral waxes and petrochemical waxes. For example, candelilla wax, carnauba wax, japan wax, esparto grass wax, cork wax, guaruma wax, rice germ oil wax, sugar cane wax, berry wax, ouricury wax, montan wax, jojoba wax, shea butter, beeswax, shellac wax, spermaceti, lanolin (wool wax), uropygial grease, ceresin, ozokerite (earth wax), paraffin waxes and microwaxes are advantageous.

Further advantageous fat and/or wax components are chemically modified waxes and synthetic waxes, such as, for example, Syncrowax® HRC (glycerol tribehenate), and Syncrowax®AW 1 C (C₁₈₋₃₆-fatty acid), and montan ester waxes, sasol waxes, hydrogenated jojoba waxes, synthetic or modified beeswaxes (e.g. dimethicone copolyol beeswax and/or C₃₀₋₅₀-alkyl beeswax), cetyl ricinoleates, such as, for example, Tegosoft®CR, polyalkylene waxes, polyethylene glycol waxes, but also chemically modified fats, such as, for example, hydrogenated vegetable oils (for example hydrogenated castor oil and/or hydrogenated coconut fatty glycerides), triglycerides, such as, for example, hydrogenated soy glyceride, trihydroxystearin, fatty acids, fatty acid esters and glycol esters, such as, for example, C₂₀₋₄₀-alkyl stearate, C₂₀₋₄₀-alkyl hydroxystearoylstearate and/or glycol montanate. Further advantageous are also certain organosilicon compounds which have similar physical properties to the specified fat and/or wax components, such as, for example, stearoxytrimethylsilane.

According to the invention, the fat and/or wax components can be used either individually or as a mixture in the compositions.

Any mixtures of such oil and wax components are also to be used advantageously for the purposes of the present invention.

The oil phase is advantageously chosen from the group consisting of 2-ethylhexyl isostearate, octyldodecanol, isotridecyl isononanoate, butylene glycol dicaprylate/dicaprate, 2-ethylhexyl cocoate, C₁₂₋₁₅-alkylbenzoate, caprylic/capric triglyceride, dicaprylyl ether.

Of particular advantage are mixtures of octyldodecanol, caprylic/capric triglyceride, dicaprylyl ether, dicaprylyl carbonate, cocoglycerides or Mixtures of C₁₂₋₁₅-alkyl benzoate and 2-ethylhexyl isostearate, mixtures of C₁₂₋₁₅-alkyl benzoate and butylene glycol dicaprylate/dicaprate, and mixtures of C₁₂₋₁₅-alkyl benzoate, 2-ethylhexyl isostearate and isotridecyl isononanoate.

Of the hydrocarbons, paraffin oil, cycloparaffin, squalane, squalene, hydrogenated polyisobutene and polydecene are to be used advantageously for the purposes of the present invention.

The oil component is also chosen advantageously from the group of phospholipids. The phospholipids are phosphoric esters of acylated glycerols. Of greatest importance among the phosphatidylcholines are, for example, the lecithins, which are characterized by the general structure

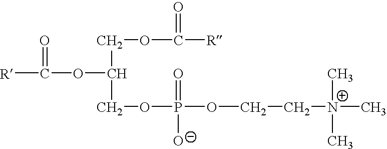

where R′ and R″ are typically unbranched aliphatic radicals having 15 or 17 carbon atoms and up to 4 cis double bonds.

Paraffin oil advantageous according to the invention which can be used in accordance with the invention is Merkur Weissoel Pharma 40 from Merkur Vaseline, Shell Ondina® 917, Shell Ondina® 927, Shell Oil 4222, Shell Ondina® 933 from Shell & DEA Oil, Pionier® 6301 S, Pionier® 2071 (Hansen & Rosenthal).

Suitable cosmetically compatible oil and fat components are described in Karl-Heinz Schrader, Grundlagen und Rezepturen der Kosmetika [Fundamentals and formulations of cosmetics], 2nd edition, Verlag Hüthig, Heidelberg, pp. 319-355, which is hereby incorporated in its entirety by reference.

### Conditioning Agents

The cosmetic compositions according to the invention already have good conditioning properties even without the addition of further conditioning agents. In a preferred embodiment, however, they comprise further conditioning agents.

Conditioning agents preferred according to the invention are, for example, all compounds which are listed in the International Cosmetic Ingredient Dictionary and Handbook (Volume 4, editor: R. C. Pepe, J. A. Wenninger, G. N. McEwen, The Cosmetic, Toiletry, and Fragrance Association, 9th edition, 2002) under Section 4 under the keywords Hair Conditioning Agents, Humectants, Skin-Conditioning Agents, Skin-Conditioning Agents-Emollient, Skin-Conditioning Agents-Humectant, Skin-Conditioning Agents-Miscellaneous, Skin-Conditioning Agents-Occlusive and Skin Protectants, and all of the compounds listed in EP-A 934 956 (pp. 11-13) under “water soluble conditioning agent” and “oil soluble conditioning agent”. Further advantageous conditioning substances are represented by, for example, the compounds referred to according to INCI as polyquaternium (in particular polyquaternium-1 to polyquaternium-56).

Suitable conditioning agents include, for example, also polymeric quaternary ammonium compounds, cationic cellulose derivatives, chitosan derivatives and polysaccharides.

Conditioning agents advantageous according to the invention can be chosen here also from the compounds shown in Table 1 below.

TABLE 1
Conditioning agents to be used advantageously

| | | | Example |
|---|---|---|---|
| INCI name | CAS number | Polymer type | (trade name) |
| Polyquaternium-2 | CAS 63451-27-4 | Urea, N,N′-bis[3-(dimethyl- | Mirapol ® A-15 |
| | | amino)propyl] polymer with | |
| | | 1,1′-oxybis(2-chloroethane) | |
| Polyquaternium-5 | CAS 26006-22-4 | Acrylamide, β-methacryloxy- | |
| | | ethyltriethylammonium | |
| | | methosulfate | |
| Polyquaternium-6 | CAS 26062-79-3 | N,N-Dimethyl-N-2-propenyl- | Merquat ® 100 |
| | | 2-propenaminium chloride | |
| Polyquaternium-7 | CAS 26590-05-6 | N,N-Dimethyl-N-2-propenyl- | Merquat ® S |
| | | 2-propenaminium chloride, | |
| | | 2-propenamide | |
| Polyquaternium-10 | CAS 53568-66-4, | Quaternary ammonium salt of | Celquat ® SC-230M, |
| | 55353-19-0, 54351-50-7, | hydroxyethylcellulose | Polymer JR 400 |
| | 68610-92-4, 81859-24-7 | | |
| Polyquaternium-11 | CAS 53633-54-8 | Vinylpyrrolidone/dimethylamino- | Gafquat ® 755N |
| | | ethyl methacrylate | |
| | | copolymer/diethyl sulfate | |
| | | reaction product | |
| Polyquaternium-16 | CAS 29297-55-0 | Vinylpyrrolidone/- | Luviquat ® HM552 |
| | | vinylimidazolinum methochloride | |
| | | copolymer | |
| Polyquaternium-17 | CAS 90624-75-2 | | Mirapol ® AD-1 |
| Polyquaternium-19 | CAS 110736-85-1 | Quaternized water-soluble | |
| | | polyvinyl alcohol | |
| Polyquaternium-20 | CAS 110736-86-2 | Quaternized polyvinyl octadecyl | |
| | | ether dispersible in water | |
| Polyquaternium-21 | | Polysiloxane-polydimethyl- | Abil ® B 9905 |
| | | dimethylammonium acetate | |
| | | copolymer | |
| Polyquaternium-22 | CAS 53694-17-0 | Dimethyldiallylammonium | Merquat ® 280 |
| | | chloride/acrylic acid copolymer | |
| Polyquaternium-24 | CAS 107987-23-5 | Polymeric quaternary | Quartisoft ® LM-200 |
| | | ammonium salt of | |
| | | hydroxyethylcellulose | |
| Polyquaternium-28 | CAS 131954-48-8 | Vinylpyrrolidone/methacrylamido | Gafquat ® HS-100 |
| | | propyltrimethylammonium | |
| | | chloride copolymer | |
| Polyquaternium-29 | CAS 92091-36-6, | Chitosan which has been | Lexquat ® CH |
| | 148800-30-2 | reacted with propylene oxide | |
| | | and quaternized with | |
| | | epichlorohydrin | |
| Polyquaternium-31 | CAS 136505-02-7, | Polymeric quaternary | Hypan ® QT 100 |
| | 139767-67-7 | ammonium salt which is | |
| | | produced via the reaction of | |
| | | DMAPA-acrylate/acrylic | |
| | | acid/acrylonitrogen copolymer | |
| | | and diethyl sulfate | |
| Polyquaternium-32 | CAS 35429-19-7 | N,N,N-Trimethyl-2-([B2-methyl- | |
| | | 1-oxo-2-propenyl)oxy]- | |
| | | ethanaminium chloride, polymer | |
| | | with 2-propenamide | |
| Polyquaternium-37 | CAS 26161-33-1 | | |
| Polyquaternium-44 | | Copolymeric quaternary | |
| | | ammonium salt of vinyl- | |
| | | pyrrolidone and quaternized | |
| | | imidazoline | |

Further conditioners advantageous according to the invention are cellulose derivatives and quaternized guar gum derivatives, in particular guar hydroxypropylammonium chloride (e.g. Jaguar Excel®, Jaguar C 162® (Rhodia), CAS 65497-29-2, CAS 39421-75-5). Nonionic poly-N-vinylpyrrolidone/polyvinyl acetate copolymers (e.g. Luviskol®VA 64 (BASF)), anionic acrylate copolymers (e.g. Luviflex® soft (BASF)), and/or amphoteric amide/acrylate/methacrylate copolymers (e.g. Amphomer® (National Starch)) can also be used advantageously as conditioners according to the invention. Further possible conditioning agents are quaternized silicones.

### Thickeners

The cosmetic compositions according to the invention can also comprise thickeners. Suitable thickeners for the compositions according to the invention are crosslinked polyacrylic acids and derivatives thereof, polysaccharides, such as xanthan gum, guar guar, agar agar, alginates or tyloses, cellulose derivatives, e.g. carboxymethylcellulose or hydroxycarboxymethylcellulose, also higher molecular weight polyethylene glycol mono- and diesters of fatty acids, fatty alcohols, monoglycerides and fatty acids, polyvinyl alcohol and polyvinylpyrrolidone.

Suitable thickeners are also polyacrylates, such as Carbopol® (Noveon), Ultrez® (Noveon), Luvigel® EM (BASF), Capigel®98 (Seppic), Synthalenee (Sigma), the Aculyn® grades from Rohm und Haas, such as Aculyn® 22 (copolymer of acrylates and methacrylic acid ethoxides with stearyl radical (20 EO units)) and Aculyn® 28 (copolymer of acrylates and methacrylic acid ethoxylates with behenyl radical (25 EO units)).

Suitable thickeners are also, for example, aerosil grades (hydrophilic silicas), polyacrylamides, polyvinyl alcohol and polyvinylpyrrolidone, surfactants, such as, for example, ethoxylated fatty acid glyercides, esters of fatty acids with polyols, such as, for example, pentaerythritol or trimethylolpropane, fatty alcohol ethoxylates with narrowed homolog distribution or alkyl oligoglucosides, and electrolytes, such as sodium chloride and ammonium chloride.

Particularly preferred thickeners for the preparation of gels are Ultrez®21, Aculyn®28, Luvigel® EM and Capigel®98.

Particularly in the case of more highly concentrated compositions, it is also possible, to regulate the consistency, to also add substances which reduce the viscosity of the formulation, such as, for example, propylene glycol or glycerol. These substances influence the product properties only slightly.

### Preservatives

The cosmetic compositions according to the invention can also comprise preservatives. Compositions with high water contents have to be reliably protected against the build-up of germs. The most important preservatives used for this purpose are urea condensates, p-hydroxybenzoic esters, the combination of phenoxyethanol with methyldibromoglutaronitrile and acid preservatives with benzoic acid, salicylic acid and sorbic acid.

Compositions with high fractions of surfactants or polyols and low water contents can also be formulated without preservatives.

The compositions according to the invention can advantageously comprise one or more preservatives. Advantageous preservatives for the purposes of the present invention are, for example, formaldehyde donors (such as, for example, DMDM hydantoin, which is commercially available, for example, under the trade name Glydant® (Lonza)), iodopropyl butylcarbamates (e.g. Glycacil-L®, Glycacil-S® (Lonza), Dekaben®LMB (Jan Dekker)), parabens (p-hydroxybenzoic alkyl esters, such as, for example, methyl-, ethyl-, propyl- and/or butylparaben), dehydroacetic acid (Euxyl® K 702 (Schülke&Mayr), phenoxyethanol, ethanol, benzoic acid. So-called preservative aids, such as, for example, octoxyglycerol, glycine, soybean etc. are also used advantageously.

The table below gives an overview of customary preservatives which may also be present in the cosmetic compositions according to the invention.

| | |
|---|---|
| E 200 | Sorbic acid |
| E 201 | Sodium sorbate |
| E 202 | Potassium sorbate |
| E 203 | Calcium sorbate |
| E 210 | Benzoic acid |
| E 211 | Sodium benzoate |
| E 212 | Potassium benzoate |
| E 213 | Calcium benzoate |
| E 214 | Ethyl p-hydroxybenzoate |
| E 215 | Ethyl p-hydroxybenzoate Na salt |
| E 216 | n-Propyl p-hydroxybenzoate |
| E 217 | n-Propyl p-hydroxybenzoate Na salt |
| E 218 | Methyl p-hydroxybenzoate |
| E 219 | Methyl p-hydroxybenzoate Na salt |
| E 220 | Sulfur dioxide |
| E 221 | Sodium sulfite |
| E 222 | Sodium hydrogensulfite |
| E 223 | Sodium disulfite |
| E 224 | Potassium disulfite |
| E 226 | Calcium sulfite |
| E 227 | Calcium hydrogensulfite |
| E 228 | Potassium hydrogensulfite |
| E 230 | Biphenyl (diphenyl) |
| E 231 | Orthophenylphenol |
| E 232 | Sodium orthophenyl phenoxide |
| E 233 | Thiabendazole |
| E 235 | Natamycin |
| E 236 | Formic acid |
| E 237 | Sodium formate |
| E 238 | Calcium formate |
| E 239 | Hexamethylenetetramine |
| E 249 | Potassium nitrite |
| E 250 | Sodium nitrite |
| E 251 | Sodium nitrate |
| E 252 | Potassium nitrate |
| E 280 | Propionic acid |
| E 281 | Sodium propionate |
| E 282 | Calcium propionate |
| E 283 | Potassium propionate |
| E 290 | Carbon dioxide |

Also advantageous are preservatives or preservative aids customary in cosmetics, such as dibromodicyanobutane (2-bromo-2-bromomethylglutarodinitrile), phenoxyethanol, 3-iodo-2-propynyl butylcarbamate, 2-bromo-2-nitropropane-1,3-diol, imidazolidinylurea, 5-chloro-2-methyl-4-isothiazolin-3-one, 2-chloroacetamide, benzalkonium chloride, benzyl alcohol, salicylic acid and salicylates.

It is particularly preferred if the preservatives used are iodopropyl butyl carbamates, parabens (methyl, ethyl, propyl and/or butyl paraben) and/or phenoxyethanol.

Complexing agents: since the raw materials and also the compositions themselves are prepared predominantly in steel apparatuses, the end products can comprise iron (ions) in trace amounts. In order to prevent these impurities adversely affecting the product quality via reactions with dyes and perfume oil constituents, complexing agents such as salts of ethylenediaminetetraacetic acid, of nitrilotriacetic acid, of iminodisuccinic acid or phosphates, are added.

UV photoprotective filters: in order to stabilize the ingredients present in the compositions according to the invention, such as, for example, dyes and perfume oils, against changes due to UV light, it is possible to incorporate UV photoprotective filters, such as, for example, benzophenone derivatives. Of suitability for this purpose are all cosmetically acceptable UV photoprotective filters. The compositions according to the invention comprise UV photoprotective filters in an amount such that the sun protection factor (SPF, determined in accordance with the COLIPA method) of the compositions is less than 4. Compositions with an SPF of at least 4 are not provided by this invention.

Examples of UV photoprotective filters which may be present in the compositions according to the invention are:

| | | CAS No. |
|---|---|---|
| No. | Substance | (= acid) |
| 1 | 4-Aminobenzoic acid | 150-13-0 |
| 2 | 3-(4′-Trimethylammonium)benzylidenebornan-2-one | 52793-97-2 |
| | methylsulfate | |
| 3 | 3,3,5-Trimethylcyclohexyl salicylate | 118-56-9 |
| | (homosalate) | |
| 4 | 2-Hydroxy-4-methoxybenzophenone | 131-57-7 |
| | (oxybenzone) | |
| 5 | 2-Phenylbenzimidazole-5-sulfonic acid and its potassium, | 27503-81-7 |
| | sodium and triethanolamine salts | |
| 6 | 3,3′-(1,4-Phenylenedimethine)bis (7,7-dimethyl- | 90457-82-2 |
| | 2-oxobicyclo[2.2.1]heptane-1-methanesulfonic acid) and its | |
| | salts | |
| 7 | Polyethoxyethyl 4-bis(polyethoxy)aminobenzoate | 113010-52-9 |
| 8 | 2-Ethylhexyl 4-dimethylaminobenzoate | 21245-02-3 |
| 9 | 2-Ethylhexyl salicylate | 118-60-5 |
| 10 | 2-Isoamyl 4-methoxycinamate | 71617-10-2 |
| 11 | 2-Ethylhexyl 4-methoxycinamate | 5466-77-3 |
| 12 | 2-Hydroxy-4-methoxybenzophenone-5-sulfonic acid | 4065-45-6 |
| | (sulisobenzone) and the sodium salt | |
| 13 | 3-(4′-Sulfobenzylidene)bornan-2-one and salts | 58030-58-6 |
| 14 | 3-Benzylidenebornan-2-one | 16087-24-8 |
| 15 | 1-(4′-Isopropylphenyl)-3-phenylpropane-1,3-dione | 63260-25-9 |
| 16 | 4-Isopropylbenzyl salicylate | 94134-93-7 |
| 17 | 3-Imidazol-4-ylacrylic acid and its ethyl ester | 104-98-3 |
| 18 | Ethyl 2-cyano-3,3-diphenylacrylate | 5232-99-5 |
| 19 | 2′-Ethylhexyl 2-cyano-3,3-diphenylacrylate | 6197-30-4 |
| 20 | Menthyl o-aminobenzoate or: | 134-09-8 |
| | 5-methyl-2-(1-methylethyl)-2-aminobenzoate | |
| 21 | Glyceryl p-aminobenzoate or: | 136-44-7 |
| | 1-glyceryl 4-aminobenzoate | |
| 22 | 2,2′-Dihydroxy-4-methoxybenzophenone (dioxybenzone) | 131-53-3 |
| 23 | 2-Hydroxy-4-methoxy-4-methylbenzophenone (mexenone) | 1641-17-4 |
| 24 | Triethanolamine salicylate | 2174-16-5 |
| 25 | Dimethoxyphenylglyoxalic acid or: | 4732-70-1 |
| | 3,4-dimethoxyphenylglyoxal acidic sodium | |
| 26 | 3-(4′-Sulfobenzylidene)bornan-2-one and its salts | 56039-58-8 |
| 27 | 4-tert-Butyl-4′-methoxydibenzoylmethane | 70356-09-1 |
| 28 | 2,2′,4,4′-Tetrahydroxybenzophenone | 131-55-5 |
| 29 | 2,2′-Methylenebis[6-(2H-benzotriazol-2-yl)- | 103597-45-1 |
| | 4-(1,1,3,3,-tetramethylbutyl)phenol] | |
| 30 | 2,2′-(1,4-Phenylene)bis-1H-benzimidazole-4,6-disulfonic acid, | 180898-37-7 |
| | Na salt | |
| 31 | 2,4-bis[4-(2-Ethylhexyloxy)-2-hydroxy]phenyl- | 187393-00-6 |
| | 6-(4-methoxyphenyl)(1,3,5)-triazine | |
| 32 | 3-(4-Methylbenzylidene)camphor | 36861-47-9 |
| 33 | Polyethoxyethyl 4-bis(polyethoxy)paraaminobenzoate | 113010-52-9 |
| 34 | 2,4-Dihydroxybenzophenone | 131-56-6 |
| 35 | 2,2′-Dihydroxy-4,4′-dimethoxybenzophenone-5,5′-disodium | 3121-60-6 |
| | sulfonate | |
| 36 | Benzoic acid, 2-[4-(diethylamino)-2-hydroxybenzoyl], hexyl ester | 302776-68-7 |
| 37 | 2-(2H-Benzotriazol-2-yl)-4-methyl-6-[2-methyl-3-[1,3,3,3- | 155633-54-8 |
| | tetramethyl-1-[(trimethylsilyl)oxy]disiloxanyl]propyl]phenol | |
| 38 | 1,1-[(2,2′-Dimethylpropoxy)carbonyl]-4,4-diphenyl-1,3-butadiene | 363602-15-7 |

Photoprotective agents suitable for use in the compositions according to the invention are also the compounds specified in EP-A 1 084 696 in paragraphs [0036] to [0053], which is hereby incorporated in its entirety at this point by reference. Of suitability for the use according to the invention are all UV photoprotective filters which are specified in Annex 7 (to § 3b) of the German Cosmetics Directive under “Ultraviolet filters for cosmetic compositions”.

The list of specified UV photoprotective filters which can be used in the compositions according to the invention is not exhaustive.

Antioxidants: an additional content of antioxidants is generally preferred. According to the invention, antioxidants which can be used are all antioxidants which are customary or suitable for cosmetic applications. The antioxidants are advantageously chosen from the group consisting of amino acids (e.g. glycine, histidins, tyrosine, tryptophan) and derivatives thereof, imidazoles (e.g. urocanic acid) and derivatives thereof, peptides, such as D,L-carnosine, D-carnosine, L-carnosine and derivatives thereof (e.g. anserine), carotenoids, carotenes, (e.g. α-carotene, β-carotene, γ-lycopene) and derivatives thereof, chlorogenic acid and derivatives thereof, lipoid acid and derivatives thereof (e.g. dihydrolipoic acid), aurothioglucose, propylthiouracil and other thiols (e.g. thioredoxin, glutathione, cysteine, cystine, cystamine and the glycosyl, n-acetyl, methyl, ethyl, propyl, amyl, butyl and lauryl, palmitoyl, oleyl, γ-linoleyl, cholesteryl and glyceryl esters thereof) and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol to μmol/kg), also (metal) chelating agents (e.g. α-hydroxy fatty acids, palmitic acid, phytic acid, lactoferrin), α-hydroxy acids (e.g. citric acid, lactic acid, malic acid), humic acid, bile acid, bile extracts, bilirubin, biliverdin, EDTA, EGTA and derivatives thereof, unsaturated fatty acids and derivatives thereof (e.g. γ-linolenic acid, linoleic acid, oleic acid), folic acid and derivatives thereof, furfurylidenesorbitol and derivatives thereof, ubiquinone and ubiquinol and derivatives thereof, vitamin C and derivatives (e.g. ascorbyl palmitate, Mg-ascorbyl phosphate, ascorbyl acetate), tocopherols and derivatives (e.g. vitamin E acetate), vitamin A and derivatives (vitamin A palmitate), and coniferyl benzoate of benzoin resin, rutinic acid and derivatives thereof, α-glycosylrutin, ferulic acid, furfurylideneglucitol, carnosine, butylhydroxytoluene, butylhydroxyanisole, nordihydroguaiacic acid, nordihydroguaiaretic acid, trihydroxybutyrophenone, uric acid and derivatives thereof, mannose and derivatives thereof, zinc and derivatives thereof (e.g. ZnO, ZnSO₄) selenium and derivatives thereof (e.g. selenomethionine), stilbenes and derivatives thereof (e.g. stilbene oxide, trans-stilbene oxide) and the derivatives (salts, esters, ethers, sugars, nucleotides, nucleosides, peptides and lipids) suitable according to the invention of these specified active ingredients.

The amount of the abovementioned antioxidants (one or more compounds) in the compositions is preferably 0.001 to 30% by weight, particularly preferably 0.05 to 20% by weight, in particular 0.1 to 10% by weight, based on the total weight of the composition.

If vitamin E and/or derivatives thereof are the antioxidant or antioxidants, it is advantageous to prepare these in concentrations of from 0.001 to 10% by weight, based on the total weight of the composition.

If vitamin A, or vitamin A derivatives, or carotenes or derivatives thereof are the antioxidant or the antioxidants, it is advantageous to prepare these in concentrations of from 0.001 to 10% by weight, based on the total weight of the composition.

Buffers: buffers ensure the pH stability of aqueous compositions according to the invention. Preference is given to using citrate, lactate and phosphate buffers.

Solubility promoters: these are used in order to form clear solutions of care oils or perfume oils and also to keep them in clear solution at low temperatures. The most common solubility promoters are ethoxylated nonionic surfactants, e.g. hydrogenated and ethoxylated castor oils.

Antimicrobial agents: in addition, it is also possible to use antimicrobial agents. These include generally all suitable preservatives with a specific effect against Gram-positive bacteria, e.g. triclosan (2,4,4′-trichloro-2′-hydroxydiphenyl ether), chlorhexidin (1,1′-hexamethylenebis[5-(4-chlorophenyl)biguanide) and TTC (3,4,4′-trichlorocarbanilide). Quaternary ammonium compounds are in principle likewise suitable. Numerous fragrances also have antimicrobial properties. A large number of essential oils and their characteristic ingredients, such as, for example, oil of cloves (eugenol), mint oil (menthol) or thyme oil (thymol) also exhibit a marked antimicrobial effectiveness.

The antibacterially effective substances are generally used in concentrations of from about 0.1 to 0.3% by weight.

Dispersants: if it is the aim to disperse insoluble active ingredients, such as antidandruff active ingredients or silicone oils, in the composition and to keep them permanently in suspension, it is advantageous to use dispersants and thickeners, such as, for example, magnesium aluminum silicates, bentonites, fatty acyl derivatives, polyvinylpyrrolidone or hydrocolloids, e.g. xanthan gum or carbomers.

According to the invention, preservatives are present in a total concentration of at most 2% by weight, preferably at most 1.5% by weight and particularly preferably at most 1% by weight, based on the total weight of the composition.

Apart from the abovementioned substances, the compositions in accordance with the invention comprise, if appropriate, the further additives customary in cosmetics, for example perfume, dyes, antimicrobial substances, refatting agents, complexing agents and sequestering agents, pearlescent agents, plant extracts, vitamins, active ingredients, preservatives, bactericides, pigments which have a coloring effect, thickeners, softening, moisturizing and/or humectant substances, all other customary constituents of a cosmetic or dermatological formulation, such as alcohols, polyols, polymers, organic acids for adjusting the pH, foam stabilizers, electrolytes, organic solvents or silicone derivatives.

### Ethoxylated Glycerol Fatty Acid Esters

The cosmetic compositions according to the invention comprise, if appropriate, ethoxylated oils chosen from the group of ethoxylated glycerol fatty acid esters, particularly preferably PEG-10 olive oil glycerides, PEG-11 avocado oil glycerides, PEG-11 cocoa butter glycerides, PEG-13 sunflower oil glycerides, PEG-15 glyceryl isostearate, PEG-9 coconut fatty acid glycerides, PEG-54 hydrogenated castor oil, PEG-7 hydrogenated castor oil, PEG-60 hydrogenated castor oil, jojoba oil ethoxylate (PEG-26 jojoba fatty acids, PEG-26 jojoba alcohol), glycereth-5 cocoate, PEG-9 coconut fatty acid glycerides, PEG-7 glyceryl cocoate, PEG-45 palm kernel oil glycerides, PEG-35 castor oil, olive oil PEG-7 ester, PEG-6 caprylic/capric glycerides, PEG-10 olive oil glycerides, PEG-13 sunflower oil glycerides, PEG-7 hydrogenated castor oil, hydrogenated palm kernel oil glyceride PEG-6 ester, PEG-20 corn oil glycerides, PEG-18 glycerol oleate cocoate, PEG-40 hydrogenated castor oil, PEG-40 castor oil, PEG-60 hydrogenated castor oil, PEG-60 corn oil glycerides, PEG-54 hydrogenated castor oil, PEG-45 palm kernel oil glycerides, PEG-80 glyceryl cocoate, PEG-60 almond oil glycerides, PEG-60 Evening Primrose glyceride, PEG-200 hydrogenated glyceryl palmate, PEG-90 glyceryl isostearate.

Preferred ethoxylated oils are PEG-7 glyceryl cocoate, PEG-9 cocoglycerides, PEG-40 hydrogenated castor oil, PEG-200 hydrogenated glyceryl palmate.

Ethoxylated glycerol fatty acid esters are used in aqueous cleaning formulations for various purposes. Glycerol fatty acid esters with low degrees of ethoxylation (3-12 ethylene oxide units) usually serve as refatting agents for improving the feel on the skin after drying, glycerol fatty acid esters with a degree of ethoxylation of from about 30-50 serve as solubility promoters for nonpolar substances such as perfume oils. Highly ethoxylated glycerol fatty acid esters are used as thickeners. It is a common property of all of these substances that during application on the skin, upon dilution with water, they produce a particular feel on the skin.

### Active Ingredients

It has been found that a very wide variety of active ingredients of varying solubility can be incorporated homogeneously into the cosmetic compositions according to the invention. The substantivity of the active ingredients on skin and hair is greater from the described composition than from conventional surfactant-containing cleaning formulations.

According to the invention, the active ingredients (one or more compounds) can be chosen advantageously from the group consisting of acetylsalicylic acid, atropine, azulene, hydrocortisone and derivatives thereof, e.g. hydrocortisone-17 valerate, vitamins of the B and D series, in particular vitamin B₁, vitamin B₁₂, vitamin D, vitamin A and derivatives thereof, such as retinol palmitate, vitamin E or derivatives thereof, such as, for example, tocopherol acetate, vitamin C and derivatives thereof, such as, for example, ascorbyl glucoside, and also niacinamide, panthenol, bisabolol, polydocanol, unsaturated fatty acids, such as, for example, the essential fatty acids (usually referred to as vitamin F), in particular γ-linolenic acid, oleic acid, eicosapentanoic acid, docosahexaenoic acid and derivatives thereof, chloramphenicol, caffeine, prostaglandins, thymol, camphor, squalene, extracts or other products of vegetable and animal origin, e.g. evening primrose oil, borage oil or blackcurrant seed oil, fish oils, cod liver oil, and also ceramides and ceramide-like compounds, incense extract, green tea extract, water lily extract, liquorice extract, hamamelis, antidandruff active ingredients (e.g. selenium disulfide, zinc pyrithione, piroctone, olamine, climbazole, octopirox, polydocanol and combinations thereof), complexing active ingredients such as, for example, those comprising γ-oryzanol and calcium salts, such as calcium panthotenate, calcium chloride, calcium acetate.

It is also advantageous to choose the active ingredients from the group of refatting substances, for example purcellin oil, Eucerit® and Neocerit®.

The active ingredient or ingredients is/are particularly advantageously also chosen from the group of NO synthase inhibitors, particularly if the compositions according to the invention are to be used for the treatment and prophylaxis of the symptoms of intrinsic and/or extrinsic skin aging, and also for the treatment and prophylaxis of the harmful effects of ultraviolet radiation on the skin and the hair. A preferred NO synthase inhibitor is nitroarginine.

The active ingredient or the active ingredients are further advantageously chosen from the group comprising catechins and bile acid esters of catechins and aqueous or organic extracts from plants or parts of plants which have a content of catechins or bile acid esters of catechins, such as, for example, the leaves of the Theaceae family, in particular the Camellia sinensis (green tea) species. Of particular advantage are their typical ingredients (e.g. polyphenols and catechins, caffeine, vitamins, sugars, minerals, amino acids, lipids).

Catechins represent a group of compounds which are to be regarded as hydrogenated flavones or anthocyanidines and represent derivatives of “catechin” (catechol, 3,3′,4′,5,7-flavanepentaol, 2-(3,4-dihydroxyphenyl)chromane-3,5,7-triol). Epicatechin ((2R,3R)-3,3′,4′,5,7-flavanepentaol) is also an advantageous active ingredient for the purposes of the present invention.

Also advantageous are plant extracts with a content of catechins, in particular extracts of green tea, such as, for example, extracts from leaves of the plants of the Camellia spec. species, very particularly of the tea varieties Camellia sinenis, C. assamica, C. taliensis and C. inawadiensis and hybrids of these with, for example, Camellia japonica.

Preferred active ingredients are also polyphenols and catechins from the group (−)-catechin, (+)-catechin, (−)-catechin gallate, (−)-gallocatechin gallate, (+)-epicatechin, (−)-epicatechin, (−)-epicatechin gallate, (−)-epigallocatechin, (−)-epigallocatechin gallate.

Flavone and its derivatives (often also collectively called flavones) are also advantageous active ingredients for the purposes of the present invention. They are characterized by the following basic structure (substitution positions given):

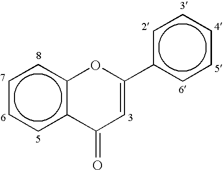

Some of the more important flavones which can also preferably be used in compositions according to the invention are listed in Table 2 below.

TABLE 2
Table 2: Flavones

| | OH substitution positions | | | | | | | |
|---|---|---|---|---|---|---|---|---|
| | 3 | 5 | 7 | 8 | 2′ | 3′ | 4′ | 5′ |
| Flavone | − | − | − | − | − | − | − | − |
| Flavonol | + | − | − | − | − | − | − | − |
| Chrysin | − | + | + | − | − | − | − | − |
| Galangin | + | + | + | − | − | − | − | − |
| Apigenin | − | + | + | − | − | − | + | − |
| Fisetin | + | − | + | − | − | + | + | − |
| Luteolin | − | + | + | − | − | + | + | − |
| Kaempferol | + | + | + | − | − | − | + | − |
| Quercetin | + | + | + | − | − | + | + | − |
| Morin | + | + | + | − | + | − | + | − |
| Robinetin | + | − | + | − | − | + | + | + |
| Gossypetin | + | + | + | + | − | + | + | − |
| Myricetin | + | + | + | − | − | + | + | + |

In nature, flavones generally occur in glycosylated form.

According to the invention, the flavonoids are preferably chosen from the group of substances of the general formula

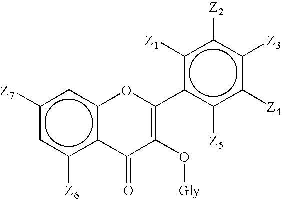

where Z₁ to Z₇, independently of one another, are chosen from the group consisting of H, OH, alkoxy and hydroxyalkoxy, where the alkoxy and/or hydroxyalkoxy groups may be branched or unbranched and have 1 to 18 carbon atoms, where Gly is chosen from the group of mono- and oligoglycoside radicals.

According to the invention, the flavonoids can, however, also be chosen advantageously from the group of substances of the general formula

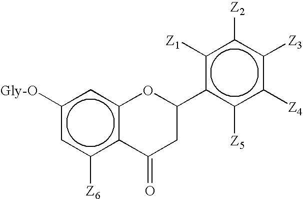

where Z₁ to Z₆, independently of one another, are chosen from the group consisting of H, OH, alkoxy and hydroxyalkoxy, where the alkoxy and hydroxyalkoxy groups may be branched and unbranched and have 1 to 18 carbon atoms, where Gly is chosen from the group of mono- and oligoglycoside radicals.

Preferably, such structures can be chosen from the group of substances of the general formula

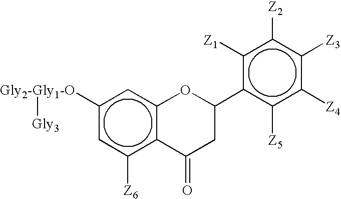

where Z₁ to Z₆, independently of one another are as specified above and Gly₁, Gly₂ and Gly₃, independently of one another, are monoglycoside radicals or oligoglycoside radicals. Gly₂ and Gly₃ can also individually or together be saturations by hydrogen atoms.

Preferably, Gly₁, Gly₂ and Gly₃, independently of one another, are chosen from the group of hexosyl radicals, in particular rhamnosyl radicals and glucosyl radicals. However, other hexosyl radicals, for example allosyl, altrosyl, galactosyl, gulosyl, idosyl, mannosyl and talosyl are also to be used advantageously if appropriate.

It can also be advantageous according to the invention to use pentosyl radicals.

Advantageously, Z₁ to Z₅, independently of one another, are chosen from the group consisting of H, OH, methoxy, ethoxy and 2-hydroxyethoxy, and the flavone glycosides correspond to the general structural formula

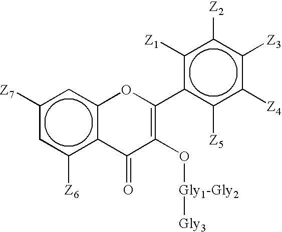

The flavone glycosides are particularly advantageously chosen from the group which is given by the following structure,

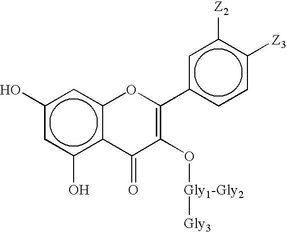

where Gly₁, Gly₂ and Gly₃, independently of one another, are monoglycoside radicals or oligoglycoside radicals. Gly₂ and Gly₃, can also individually or together be saturations by hydrogen atoms.

Preferably, Gly₁, Gly₂ and Gly₃, independently of one another, are chosen from group of hexosyl radicals, in particular rhamnosyl radicals and glucosyl radicals. However, other hexosyl radicals, for example, allosyl, altrosyl, galactosyl, gulosyl, idosyl, mannosyl and talosyl, are also to be used advantageously if appropriate.

It may also be advantageous according to the invention to use pentosyl radicals.

It is particularly advantageous for the purposes of the present invention to choose the flavone glycoside or flavone glycosides from the group consisting of α-glucosylrutin, α-glucosylmyricetin, α-glucosylisoquercitrin, α-glucosylisoquercetin and α-glucosylquercitrin.

Further advantageous active ingredients are sericoside, pyridoxol, vitamin K, biotin and aroma substances.

Furthermore, the active ingredients (one or more compounds) can also very advantageously be chosen from the group of hydrophilic active ingredients, in particular from the following group:

α-hydroxy acids, such as lactic acid or salicylic acid and salts thereof, such as, for example, Na lactate, Ca lactate, TEA lactate, urea, allantoin, serine, sorbitan, glycerol, milk proteins, panthenol, chitosan.

The list of specified active ingredients and active ingredient combinations which can be used in the compositions according to the invention is not of course intended to be limiting. The active ingredients can be used individually or in any combinations with one another.

The amount of such active ingredients (one or more compounds) in the compositions according to the invention is preferably 0.001 to 30% by weight, particularly preferably 0.05 to 20% by weight, in particular 1 to 10% by weight, based on the total weight of the composition.

The specified and further active ingredients which can be used in the compositions according to the invention are given in DE 103 18 526 A1 on pages 12 to 17, which is hereby incorporated in its entirety at this point by reference.

### Pearlescent Waxes

Suitable pearlescent waxes are, for example: alkylene glycol esters, specifically ethylene glycol distearate; fatty acid alkanolamides, specifically coconut fatty acid diethanolamide; partial glycerides, specifically stearic acid monoglyceride; esters of polybasic, optionally hydroxy-substituted carboxylic acids with fatty alcohols having 6 to 22 carbon atoms, specifically long-chain esters of tartaric acid; fatty substances, such as, for example, fatty alcohols, fatty ketones, fatty aldehydes, fatty ethers and fatty carbonates which have a total of at least 24 carbon atoms, specifically laurone and distearyl ether; fatty acids, such as stearic acid, hydroxystearic acid or behenic acid, ring-opening products of olefin epoxides having 12 to 22 carbon atoms with fatty alcohols having 12 to 22 carbon atoms and/or polyols having 2 to 15 carbon atoms and 2 to 10 hydroxyl groups, and mixtures thereof.

The compositions according to the invention can also comprise glitter substances and/or other effect substances (e.g. color streaks).

### Emulsifiers

The cosmetic compositions according to the invention are in the form of emulsions in a preferred embodiment of the invention. Such emulsions are prepared by known methods. Besides copolymer a) and, if appropriate, oligomer b), the emulsions can comprise customary constituents, such as fatty alcohols, fatty acid esters and, in particular, fatty acid triglycerides, fatty acids, lanolin and derivatives thereof, natural or synthetic oils or waxes and emulsifiers in the presence of water. The choice of additives specific to the type of emulsion and the preparation of suitable emulsions is described, for example, in Schrader, Grundlagen und Rezepturen der Kosmetika [Fundamentals and formulations of cosmetics], Hüthig Buch Verlag, Heidelberg, 2nd edition, 1989, third part, which is hereby expressly incorporated by reference.

A suitable emulsion, e.g. for a skin cream, generally comprises an aqueous phase which is emulsified in an oil or fatty phase by means of a suitable emulsifier system.

The fraction of emulsifier system in this type of emulsion is preferably about 4 to 35% by weight, based on the total weight of the emulsion. The fraction of the fatty phase is preferably about 20 to 60% by weight. Preferably, the fraction of the aqueous phase is about 20 and 70%, in each case based on the total weight of the emulsion.

Suitable emulsifiers are, for example, nonionogenic surfactants from at least one of the following groups:
(1) addition products of from 2 to 30 mol of ethylene oxide and/or 0 to 5 mol of propylene oxide onto linear fatty alcohols having 8 to 22 carbon atoms, onto fatty acids having 12 to 22 carbon atoms and onto alkylphenols having 8 to 15 carbon atoms in the alkyl group;
(2) C12/18 fatty acid mono- and diesters of addition products of from 1 to 30 mol of ethylene oxide onto glycerol;
(3) glycerol mono- and diesters and sorbitan mono- and diesters of saturated and unsaturated fatty acids having 6 to 22 carbon atoms and ethylene oxide addition products thereof;
(4) alkyl mono- and oligoglycosides having 8 to 22 carbon atoms in the alkyl radical and ethoxylated analogs thereof;
(5) addition products of from 15 to 60 mol of ethylene oxide onto oils, for example, onto castor oil and/or hydrogenated castor oil;
(6) polyol, and in particular polyglycerol, esters, such as, for example, polyglycerol polyricinoleate, polyglycerol poly-12-hydroxystearate or polyglycerol dimerate. Mixtures of compounds from two or more of these classes of substances are likewise suitable;
(7) addition products of from 2 to 15 mol of ethylene oxide onto castor oil and/or hydrogenated castor oil;
(8) partial esters based on linear, branched, unsaturated or saturated C_{6/22}-fatty acids, ricinoleic acid, and 12-hydroxystearic acid and glycerol, polyglycerol, pentaerythritol, dipentaerythritol, sugar alcohols (e.g. soribtol), alkyl glucosides (e.g. methyl glucoside, butyl glucoside, lauryl glucoside), and polyglucosides (e.g. cellulose);
(9) mono-, di- and trialkyl phosphates, and mono-, di- and/or tri-PEG alkyl phosphates and salts thereof;
(10) wool wax alcohols;
(11) polysiloxane-polyalkyl-polyether copolymers and corresponding derivatives;
(12) mixed esters of pentaerythritol, fatty acids, citric acid and fatty alcohols according to DE-C 1165574 and/or mixed esters of fatty acids having 6 to 22 carbon atoms, methylglycose and polyols, preferably glycerol or polyglycerol and
(13) polyalkylene glycols.

The addition products of ethylene oxide and/or of propylene oxide onto fatty alcohols, fatty acids, alkylphenols, glycerol mono- and diesters, and sorbitan mono- and diesters of fatty acids or onto castor oil are known, commercially available products. These are homolog mixtures whose average degree of alkoxylation corresponds to the ratio of the quantitative amounts of ethylene oxide and/or propylene oxide and substrate with which the addition reaction is carried out. C₁₂ to C₁₈-fatty acid mono- and diesters of addition products of ethylene oxide onto glycerol are known from DE-C 2024051 as refatting agents for cosmetic compositions. C₈ to C₁₈-alkyl mono- and oligoglycosides, their preparation and their use are known from the prior art. Their preparation takes place in particular by reacting glucose or oligosaccharides with primary alcohols having 8 to 18 carbon atoms. As regards the glycoside ester, both monoglycosides in which a cyclic sugar radical is bonded glycosidically to the fatty alcohol, and also oligomeric glycosides with a degree of oligomerization up to preferably about 8 are suitable. The degree of oligomerization here is a statistical average value which is based on a homolog distribution customary for such technical products.

In addition, zwitterionic surfactants can be used as emulsifiers. Zwitterionic surfactants is the term used to describe those surface-active compounds which carry at least one quaternary ammonium group and at least one carboxylate and/or one sulfonate group in the molecule. Particularly suitable zwitterionic surfactants are the so-called betaines, such as the N-alkyl-N,N-dimethylammonium glycinates, for example cocoalkyldimethylammonium glycinate, N-acylaminopropyl-N,N-dimethylammonium glycinates, for example cocoacylaminopropyldimethylammonium glycinate, and 2-alkyl-3-carboxylmethyl-3-hydroxyethylimidazolines having in each case 8 to 18 carbon atoms in the alkyl or acyl group, and cocoacylaminoethyl hydroxyethylcarboxymethyl glycinate.

Of particular preference is the fatty acid amide derivative known under the CTFA name Cocamidopropyl Betaine. Likewise suitable emulsifiers are ampholytic surfactants. Ampholytic surfactants are understood as meaning those surface-active compounds which, apart from a C₈ to C₁₈-alkyl or -acyl group in the molecule, comprise at least one free amino group and at least one —COOH and/or —SO3H group and are capable of forming internal salts. Examples of suitable ampholytic surfactants are N-alkylglycines, N-alkylpropionic acids, N-alkylaminobutyric acids, N-alkyliminodipropionic acids, N-hydroxyethyl-N-alkylamidopropylglycines, N-alkyltaurines, N-alkylsarcosines, 2-alkylaminopropionic acids and alkylaminoacetic acids having in each case about 8 to 18 carbon atoms in the alkyl group. Particularly preferred ampholytic surfactants are N-cocoalkylaminopropionate, cocoacylaminoethylaminopropionate and C₁₂ to C₁₈-acylsarcosine.

Besides the ampholytic emulsifiers, quaternary emulsifiers are also suitable, particular preference being given to those of the ester quat type, preferably methyl-quaternized difatty acid triethanolamine ester salts.

### Perfume Oils

If appropriate, the cosmetic compositions according to the invention can comprise perfume oils. Perfume oils which may be mentioned are, for example, mixtures of natural and synthetic fragrances. Natural fragrances are extracts from flowers (lily, lavender, rose, jasmine, neroli, ylang-ylang), stems and leaves (geranium, patchouli, petitgrain), fruits (anise, coriander, cumin, juniper), fruit peels (bergamot, lemon, orange), roots (mace, angelica, celery, cardamom, costus, iris, calmus), woods (pine wood, sandalwood, guaiac wood, cedar wood, rose wood), herbs and grasses (tarragon, lemon grass, sage, thyme), needles and branches (spruce, fir, pine, dwarf-pine), resins and balsams (galbanum, elemi, benzoin, myrrh, olibanum, opoponax). Also suitable are animal raw materials, such as, for example, civet and castoreum. Typical synthetic fragrance compounds are products of the ester, ether, aldehyde, ketone, alcohol and hydrocarbon type. Fragrance compounds of the ester type are, for example, benzyl acetate, phenoxyethyl isobutyrate, 4-tert-butyl cyclohexylacetate, linalyl acetate, dimethylbenzylcarbinyl acetate, phenylethyl acetate, linalyl benzoate, benzyl formate, ethylmethyl phenylglycinate, allyl cyclohexylpropionate, styrallyl propionate and benzyl salicylate. The ethers include, for example, benzyl ethyl ether, the aldehydes include, for example, the linear alkanals having 8 to 18 carbon atoms, citral, citronellal, citronellyloxyacetaldehyde, cyclamenaldehyde, hydroxycitronellal, lilial and bourgeonat, the ketones include, for example, the ionones, cc-isomethylionene and methyl cedryl ketone, the alcohols include anethol, citronellol, eugenol, isoeugenol, geraniol, linalool, phenylethyl alcohol and terioneol, the hydrocarbons include primarily the terpenes and balsams. However, preference is given to using mixtures of different fragrances which together produce a pleasing scent note. Essential oils of lower volatility, which are mostly used as aroma components, are also suitable as perfume oils, e.g. sage oil, camomile oil, oil of cloves, melissa oil, mint oil, cinnamon leaf oil, linden blossom oil, juniperberry oil, vetiver oil, olibanum oil, galbanum oil, labolanum oil and lavandin oil. Preference is given to using bergamot oil, dihydromyrcenol, lilial, lyral, citronellol, phenylethyl alcohol, α-hexylcinnamaldehyde, geraniol, benzyl acetone, cyclamenaldehyde, linalool, Boisambrene®Forte, ambroxan, indole, hedione, sandelice, citrus oil, mandarin oil, orange oil, allyl amyl glycolate, cyclovertal, lavandin oil, clary sage oil, β-damascone, geranium oil bourbon, cyclohexyl salicylate, Vertofix®Coeur, Iso-E-Super®, Fixolide®NP, evernyl, iraldein gamma, phenylacetic acid, geranyl acetate, benzyl acetate, rose oxide, romillat, irotyl and floramat alone or in mixtures.

### Pigments

If appropriate, the cosmetic compositions according to the invention further comprise pigments.

The pigments are present in the product mass in undissolved form and may be present in an amount of from 0.01 to 25% by weight, particularly preferably from 5 to 15% by weight. The preferred particle size is 1 to 200 μm, in particular 3 to 150 μm, particularly preferably 10 to 100 μm. The pigments are colorants which are virtually insoluble in the application medium and may be inorganic or organic. Inorganic-organic mixed pigments are also possible. Preference is given to inorganic pigments. The advantage of the inorganic pigments is their excellent fastness to light, weather and temperature. The inorganic pigments can be of natural origin, for example prepared from chalk, ocher, umber, green earth, burnt sienna or graphite. The pigments may be white pigments, such as, for example, titanium dioxide or zinc oxide, black pigments, such as, for example, iron oxide black, colored pigments, such as, for example, ultramarine or iron oxide red, luster pigments, metal effect pigments, pearlescent pigments, and fluorescent or phosphorescent pigments, where preferably at least one pigment is a colored, non-white pigment.

Metal oxides, hydroxides and oxide hydrates, mixed phase pigments, sulfur-containing silicates, metal sulfides, complex metal cyanides, metal sulfates, chromates and molybdates, and the metals themselves (bronze pigments) are suitable. Of particular suitability are titanium dioxide (CI 77891), black iron oxide (CI 77499), yellow iron oxide (CI 77492), red and brown iron oxide (CI 77491), manganese violet (CI 77742), ultramarine (sodium aluminum sulfosicilates, CI 77007, Pigment Blue 29), chromium oxide hydrate (CI 77289), iron blue (ferric ferrocyanide, CI 77510), carmine (cochineal).

Particular preference is given to pearlescent and color pigments based on mica which are coated with a metal oxide or a metal oxychloride such as titanium dioxide or bismuth oxychloride, and, if appropriate, further color-imparting substances such as iron oxides, iron blue, ultramarine, carmine etc. and where the color can be determined by varying the layer thickness. Such pigments are sold, for example, under the trade names Rona®, Colorona®, Dichrona® and Timiron® (Merck).

Organic pigments are, for example, the natural pigments sepia, gamboge, bone charcoal, cassel brown, indigo, chlorophyll and other plant pigments. Synthetic organic pigments are, for example, azo pigments, anthraquinoids, indigoids, dioxazine, quinacridone, phthalocyanine, isoindolinone, perylene and perinone, metal complex, alkali blue and diketopyrrolopyrrole pigments.

In one embodiment, the composition according to the invention comprises 0.01 to 10% by weight, particularly preferably from 0.05 to 5% by weight, of at least one particulate substance. Suitable substances are, for example, substances which are solid at room temperature (25° C.) and are in the form of particles. For example, silica, silicates, aluminates, clay earths, mica, salts, in particular inorganic metal salts, metal oxides, e.g. titanium dioxide, minerals and polymer particles are suitable.

The particles are present in the composition undissolved, preferably in stably dispersed form and, following application to the application surface and evaporation of the solvent, can settle out in solid form.

Preferred particulate substances are silica (silica gel, silicon dioxide) and metal salts, in particular inorganic metal salts, particular preference being given to silica. Metal salts are, for example, alkali metal or alkaline earth metal halides, such as sodium chloride or potassium chloride; alkali metal or alkaline earth metal sulfates, such as sodium sulfate or magnesium sulfate.

### Polymers

The cosmetic compositions according to the invention can also comprise additional polymers.

Suitable polymers are, for example, cationic polymers with the INCI name Polyquaternium, e.g. copolymers of vinylpyrrolidone/N-vinylimidazolium salts (Luviquat® FC, Luviquat® HM, Luviquat® MS, Luviquat® Care, Luviquat® UltraCare), copolymers of N-vinylpyrrolidone/dimethylaminoethyl methacrylate quaternized with diethyl sulfate (Luviquat® PQ 11), copolymers of N-vinylcaprolactam/N-vinylpyrrolidone/N-vinylimidazolium salts (Luviquat® Hold); cationic cellulose derivatives (polyquaternium-4 and -10), acrylamidocopolymers (polyquaternium-7) and chitosan. Suitable cationic (quaternized) polymers are also Merquat® (polymer based on dimethyldiallylammonium chloride), Gafquat® (quaternary polymers which are formed by reacting polyvinylpyrrolidone with quaternary ammonium compounds), polymer JR (hydroxyethylcellulose with cationic groups) and cationic polymers based on plants, e.g. guar polymers, such as the Jaguar® grades from Rhodia.

Further suitable polymers are also neutral polymers, such as polyvinylpyrrolidones, copolymers of N-vinylpyrrolidone and vinyl acetate and/or vinyl propionate and/or stearyl(meth)acrylate, polysiloxanes, polyvinylcaprolactam and other copolymers with N-vinylpyrrolidone, polyethyleneimines und salts thereof, polyvinylamines and salts thereof, cellulose derivatives, polyaspartic acid salts and derivatives. These include, for example, Luviflex® Swing (partially hydrolyzed copolymer of polyvinyl acetate and polyethylene glycol, BASF) or Kollicoat® IR.

Suitable polymers are also the (meth)acrylamide copolymers described in WO 03/092640, in particular those described as Examples 1 to 50 (Table 1, page 40 ff.) and Examples 51 to 65 (Table 2, page 43), which is hereby incorporated in its entirety at this point by reference.

Suitable polymers are also nonionic, water-soluble or water-dispersible polymers or oligomers, such as polyvinylcaprolactam, e.g. Luviskol® Plus (BASF), or polyvinylpyrrolidone and copolymers thereof, in particular with vinyl esters, such as vinyl acetate, e.g. Luviskol® VA 37 (BASF); polyamides, e.g. based on itaconic acid and aliphatic diamines, as are described, for example, in DE-A-43 33 238.

Suitable polymers are also amphoteric or zwitterionic polymers, such as the octylacrylamide/methyl methacrylate/tert-butylaminoethyl methacrylate/2-hydroxypropyl methacrylate copolymers obtainable under the names Amphomer® (National Starch), and zwitterionic polymers as are disclosed, for example, in the German patent applications DE 39 29 973, DE 21 50 557, DE 28 17 369 and DE 37 08 451. Acrylamidopropyltrimethylammonium chloride/acrylic acid or methacrylic acid copolymers and alkali metal and ammonium salts thereof are preferred zwitterionic polymers. Further suitable zwitterionic polymers are

methacroylethylbetaine/methacrylate copolymers, which are commercially available under the name Amersette® (AMERCHOL), and copolymers of hydroxyethyl methacrylate, methyl methacrylate, N,N-dimethylaminoethyl methacrylate and acrylic acid (Jordapon®).

Suitable polymers are also nonionic, siloxane-containing, water-soluble or -dispersible polymers, e.g. polyether siloxanes, such as Tegopren® (Goldschmidt) or Belsil® (Wacker).

Furthermore, biopolymers are also suitable, i.e. polymers which are obtained from naturally renewable raw materials and are constructed from natural monomer building blocks, e.g. cellulose derivatives, chitin, chitosan, DNA, hyaluronic acid and RNA derivatives.

Further compositions according to the invention comprise at least one further water-soluble polymer, in particular chitosans (poly(D-glucosamines)) of varying molecular weight and/or chitosan derivatives.

### Anionic Polymers

Further polymers suitable for the compositions according to the invention are copolymers containing carboxylic acid groups. These are polyelectrolytes with a relatively large number of anionically dissociable groups in the main chain and/or one side chain. They are capable of forming polyelectrolyte complexes (symplexes) with the copolymers A).

In a preferred embodiment, the polyelectrolyte complexes used in compositions according to the invention have an excess of anionogenic/anionic groups.

Besides at least one of the abovementioned copolymers A), the polyelectrolyte complexes also comprise at least one polymer containing acid groups.

The polyelectrolyte complexes preferably comprise copolymer(s) A) and polymers containing acid groups in a quantitative ratio by weight of from about 50:1 to 1:20, particularly preferably from 20:1 to 1:5.

Suitable polymers containing carboxylic acid groups are obtainable, for example, by free-radical polymerization of α,β-ethylenically unsaturated monomers. Here, monomers m1) are used which comprise at least one free-radically polymerizable, α,β-ethylenically unsaturated double bond and at least one anionogenic and/or anionic group per molecule.

Suitable polymers containing carboxylic acids are also polyurethanes containing carboxylic acid groups. Preferably, the monomers are chosen from monoethylenically unsaturated carboxylic acids, sulfonic acids, phosphonic acids and mixtures thereof.

The monomers m1) include monoethylenically unsaturated mono- and dicarboxylic acids having 3 to 25, preferably 3 to 6, carbon atoms, which can also be used in the form of their salts or anhydrides. Examples thereof are acrylic acid, methacrylic acid, ethacrylic acid, α-chloracrylic acid, crotonic acid, maleic acid, maleic anhydride, itaconic acid, citraconic acid, mesaconic acid, glutaconic acid, aconitic acid and fumaric acid. The monomers also include the half-esters of monoethylenically unsaturated dicarboxylic acids having 4 to 10, preferably 4 to 6, carbon atoms, e.g. of maleic acid, such as monomethyl maleate. The monomers also include monoethylenically unsaturated sulfonic acids and phosphonic acids, for example vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryloxypropylsulfonic acid, styrenesulfonic acid, 2-acrylamido-2-methylpropanesulfonic acid, vinylphosphonic acid and allylphosphonic acid. The monomers also include the salts of the abovementioned acids, in particular the sodium, potassium and ammonium salts, and the salts with the abovementioned amines. The monomers can be used as they are or as mixtures with one another. The weight fractions given all refer to the acid form.

Preferably, the monomer m1) is chosen from acrylic acid, methacrylic acid, ethacrylic acid, α-chloroacrylic acid, crotonic acid, maleic acid, maleic anhydride, fumaric acid, itaconic acid, citraconic acid, mesaconic acid, glutaconic acid, aconitic acid and mixtures thereof, particularly preferably acrylic acid, methacrylic acid and mixtures thereof.

The abovementioned monomers m1) can in each case be used individually or in the form of any mixtures.

Of suitability in principle as comonomers for the preparation of the polymers containing carboxylic acid groups are the compounds a) to d) given above as components of copolymer A) with the proviso that the mole fraction of anionogenic and anionic groups which comprise the copolymerized polymer containing carboxylic acid groups is larger than the mole fraction of cationogenic and cationic groups.

In a preferred embodiment, the polymers containing carboxylic acid groups comprise at least one monomer in copolymerized form which is chosen from the above-mentioned crosslinkers d). Reference is made to suitable and preferred crosslinkers d).

Furthermore, the polymers containing carboxylic acid groups preferably comprise at least one monomer m2) in copolymerized form which is chosen from compounds of the general formula (VI)

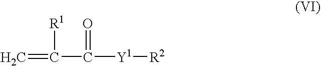

in which
R¹ is hydrogen or C₁-C₈-alkyl,
Y¹ is O, NH or NR³, and
R² and R³ independently of one another are C₁-C₃₀-alkyl or C₅-C₈-cycloalkyl, where the alkyl groups may be interrupted by up to four nonadjacent heteroatoms or heteroatom-containing groups which are chosen from O, S and NH.

Preferably, R¹ in the formula VI is hydrogen or C₁-C₄-alkyl, in particular hydrogen, methyl or ethyl. Preferably, R² in the formula VI is C₁-C₈-alkyl, preferably methyl, ethyl, n-butyl, isobutyl, tert-butyl or a group of the formula —CH₂—CH₂—NH—C(CH₃)₃. If R³ is alkyl, then it is preferably C₁-C₄-alkyl, such as methyl, ethyl, n-propyl, n-butyl, isobutyl or tert-butyl.

Suitable monomers m2) are methyl(meth)acrylate, methyl ethacrylate, ethyl (meth)acrylate, ethyl ethacrylate, tert-butyl(meth)acrylate, tert-butyl ethacrylate, n-octyl (meth)acrylate, 1,1,3,3-tetramethylbutyl(meth)acrylate, ethylhexyl(meth)acrylate, n-nonyl(meth)acrylate, n-decyl(meth)acrylate, n-undecyl(meth)acrylate, tridecyl (meth)acrylate, myristyl(meth)acrylate, pentadecyl(meth)acrylate, palmityl (meth)acrylate, heptadecyl(meth)acrylate, nonadecyl(meth)acrylate, arrachinyl (meth)acrylate, behenyl(meth)acrylate, lignocerenyl(meth)acrylate, cerotinyl (meth)acrylate, melissinyl(meth)acrylate, palmitoleinyl(meth)acrylate, oleyl (meth)acrylate, linolyl(meth)acrylate, linolenyl(meth)acrylate, stearyl(meth)acrylate, lauryl(meth)acrylate and mixtures thereof.

Suitable monomers m2) are also acrylamide, methacrylamide, N-methyl(meth)-acrylamide, N-ethyl(meth)acrylamide, N-propyl(meth)acrylamide, N-(n-butyl)(meth)-acrylamide, N-(tert-butyl)(meth)acrylamide, N,N-dimethyl(meth)acrylamide, N,N-diethyl(meth)acrylamide, piperidinyl(meth)acrylamide and morpholinyl-(meth)acrylamide, N-(n-octyl)(meth)acrylamide, N-(1,1,3,3-tetramethylbutyl)-(meth)acrylamide, N-ethylhexyl(meth)acrylamide, N-(n-nonyl)(meth)acrylamide, N-(n-decyl)(meth)acrylamide, N-(n-undecyl)(meth)acrylamide, N-tridecyl-(meth)acrylamide, N-myristyl(meth)acrylamide, N-pentadecyl(meth)acrylamide, N-palmityl(meth)acrylamide, N-heptadecyl(meth)acrylamide, N-nonadecyl(meth)-acrylamide, N-arrachinyl(meth)acrylamide, N-behenyl(meth)acrylamide, N-lignocerenyl(meth)acrylamide, N-cerotinyl(meth)acrylamide, N-melissinyl(meth)-acrylamide, N-palmitoleinyl(meth)acrylamide, N-oleyl(meth)acrylamide, N-linolyl-(meth)acrylamide, N-linolenyl(meth)acrylamide, N-stearyl(meth)acrylamide and N-lauryl(meth)acrylamide.

Furthermore, the polymers containing carboxylic acid groups preferably comprise at least one monomer m3) in copolymerized form which is chosen from compounds of the general formula VII

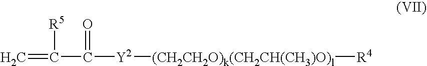

in which
the order of the alkylene oxide units is arbitrary,
k and l independently of one another are an integer from 0 to 1000, where the sum of k and l is at least 5,
R⁴ is hydrogen, C₁-C₃₀-alkyl or C₅-C₈-cycloalkyl,
R⁵ is hydrogen or C₁-C₈-alkyl,
Y² is O or NR⁶, where R⁶ is hydrogen, C₁-C₃₀-alkyl or C₅-C₈-cycloalkyl.

Preferably, in the formula VII, k is an integer from 1 to 500, in particular 3 to 250. Preferably, l is an integer from 0 to 100. Preferably, R⁵ is hydrogen, methyl, ethyl, n-propyl, isopropyl, n-butyl, sec-butyl, tert-butyl, n-pentyl or n-hexyl, in particular hydrogen, methyl or ethyl. Preferably R⁴ in the formula VII is hydrogen, methyl, ethyl, n-propyl, isopropyl, n-butyl, sec-butyl, n-pentyl, n-hexyl, octyl, 2-ethylhexyl, decyl, lauryl, palmityl or stearyl. Preferably, Y² in the formula VII is O or NH.

Suitable polyether acrylates VII) are, for example, the polycondensation products of the abovementioned α,β-ethylenically unsaturated mono- and/or dicarboxylic acids and the acid chlorides, amides and anhydrides thereof with polyetherols. Suitable polyetherols can be readily prepared by reacting ethylene oxide, 1,2-propyleneoxide and/or epichlorohydrin with a starter molecule, such as water or a short-chain alcohol R⁴—OH. The alkylene oxides can be used individually, alternately one after the other or as a mixture. The polyether acrylates VII) can be used on their own or in mixtures for preparing the polymers used according to the invention. Suitable polyether acrylates II) are also urethane (meth)acrylates with alkylene oxide groups. Such compounds are described in DE 198 38 851 (component e2)), which is hereby incorporated in its entirety by reference.

Anionic polymers preferred as polymers containing carboxylic acid groups are, for example, homopolymers and copolymers of acrylic acid and methacrylic acid and salts thereof. These also include crosslinked polymers of acrylic acid, as are obtainable under the INCI name Carbomer. Such crosslinked homopolymers of acrylic acid are available commercially, for example, under the name Carbopol® from Noveon. Preference is also given to hydrophobically modified crosslinked polyacrylate polymers such as Carbopol® Ultrez 21 from Noveon.

Further examples of suitable anionic polymers are copolymers of acrylic acid and acrylamide and salts thereof; sodium salts of polyhydroxycarboxylic acids, water-soluble or water-dispersible polyesters, polyurethanes and polyureas. Particularly suitable polymers are copolymers of (meth)acrylic acid and polyether acrylates, where the polyether chain is terminated with a C₈-C₃₀-alkyl radical. These include, for example, acrylate/beheneth-25 methacrylate copolymers, which are available under the name Aculyn® from Rohm and Haas. Particularly suitable polymers are also copolymers of t-butyl acrylate, ethyl acrylate, methacrylic acid (e.g. Luvimer® 100P, Luvimer® Pro55), copolymers of ethyl acrylate and methacrylic acid (e.g. Luviumer® MAE), copolymers of N-tert-butylacrylamide, ethyl acrylate, acrylic acid (Ultrahold® 8, Ultrahold® Strong), copolymers of vinyl acetate, crotonic acid and, if appropriate, further vinyl esters (e.g. Luviset® grades), maleic anhydride copolymers, if appropriate reacted with alcohol, anionic polysiloxanes, e.g. carboxyfunctional ones, t-butyl acrylate, methacrylic acid (e.g. Luviskol® VBM), copolymers of acrylic acid and methacrylic acid with hydrophobic monomers, such as, for example, C₄-C₃₀-alkyl esters of meth(acrylic acid), C₄-C₃₀-alkylvinyl esters, C₄-C₃₀-alkyl vinyl ethers and hyaluronic acid. Examples of anionic polymers are also vinyl acetate/crotonic acid copolymers, as are sold, for example, under the names Resyn® (National Starch) and Gafset® (GAF), and vinylpyrrolidone/vinyl acrylate copolymers obtainable, for example, under the trade name Luviflex® (BASF). Further suitable polymers are the vinylpyrrolidone/acrylate terpolymer obtainable under the name Luviflex® VBM-35 (BASF) and polyamides containing sodium sulfonate or polyesters containing sodium sulfonate.

In addition, the group of suitable anionic polymers comprises, by way of example, Balance® CR (National Starch; acrylate copolymer), Balance® 0/55 (National Starch; acrylate copolymer), Balance® 47 (National Starch;

octylacrylamide/acrylate/butylaminoethyl methacrylate copolymer), Aquaflex® FX 64 (ISP; isobutylene/ethylmaleimide/hydroxyethylmaleimide copolymer), Aquaflex® SF-40 (ISP/National Starch; VP/vinylcaprolactam/DMAPA acrylate copolymer), Allianz® LT-120 (ISP/Rohm & Haas; acrylate/C1-2 succinate/hydroxyacrylate copolymer), Aquarez® HS (Eastman; polyester-1), Diaformer® Z-400 (Clariant; methacryloylethylbetaine/methacrylate copolymer), Diaformer® Z-711 (Clariant; methacryloylethyl N-oxide/methacrylate copolymer), Diaformer® Z-712 (Clariant; methacryloylethyl N-oxide/methacrylate copolymer), Omnirez® 2000 (ISP; monoethyl ester of poly(methyl vinyl ether/maleic acid in ethanol), Amphomer® HC (National Starch; acrylate/octylacrylamide copolymer), Amphomer® 28-4910 (National Starch; octylacrylamide/acrylate/butylaminoethyl methacrylate copolymer), Advantage® HC 37 (ISP; terpolymer of vinylcaprolactam/vinylpyrrolidone/dimethylaminoethyl methacrylate), Advantage® LC55 and LC80 or LC A and LC E, Advantage® Plus (ISP; VA/butyl maleate/isobornyl acrylate copolymer), Aculyn® 258 (Rohm & Haas; acrylate/hydroxy ester acrylate copolymer), Luviset® P.U.R. (BASF, polyurethane-1), Luviflex® Silk (BASF), Eastman® AQ 48 (Eastman), Styleze® CC-10 (ISP; VP/DMAPA acrylates copolymer), Styleze® 2000 (ISP; VP/acrylates/lauryl methacrylate copolymer), DynamX® (National Starch; polyurethane-14 AMP-acrylates copolymer), Resyn XP® (National Starch; acrylates/octylacrylamide copolymer), Fixomer® A-30 (Ondeo Nalco; polymethacrylic acid (and) acrylamidomethylpropanesulfonic acid), Fixate® G-100 (Noveon; AMP-acrylates/allyl methacrylate copolymer).

Suitable polymers containing carboxylic acid groups are also the terpolymers of vinylpyrrolidone, C₁-C₁₀-alkyl, cycloalkyl and aryl(meth)acrylates and acrylic acid described in U.S. Pat. No. 3,405,084. Suitable polymers containing carboxylic acid groups are also the terpolymers of vinylpyrrolidone, tert-butyl(meth)acrylate and (meth)acrylic acid described in EP-A-0 257 444 and EP-A-0 480 280. Suitable polymers containing carboxylic acid groups are also the copolymers described in DE-A-42 23 066 which comprise, in copolymerized form, at least one (meth)acrylic ester, (meth)acrylic acid and N-vinylpyrrolidone and/or N-vinylcaprolactam. The disclosure of these documents is hereby incorporated in its entirety by reference.

The abovementioned polymers containing carboxylic acid groups are prepared by known processes, for example solution, precipitation, suspension or emulsion polymerization, as described above for the copolymers A).

Suitable polymers containing carboxylic acid groups are also polyurethanes containing carboxylic acid groups.

EP-A-636361 discloses suitable block copolymers with polysiloxane blocks and polyurethane/polyurea blocks which have carboxylic acid and/or sulfonic acid groups. Suitable silicone-containing polyurethanes are also described in WO 97/25021 and EP-A-751162.

Suitable polyurethanes are also described in DE-A-42 25 045, which is hereby incorporated in its entirety by reference.

The acid groups of the polymers containing carboxylic acid groups can be partially or completely neutralized. At least some of the acid groups are then present in deprotonated form, the counterions preferably being chosen from alkali metal ions, such as Na⁺, K⁺, ammonium ions and organic derivatives thereof etc.

### Propellants (Propellant Gases)

If the compositions according to the invention are to be provided as aerosol spray, propellants are necessary. Suitable propellants (propellant gases) are the customary propellants, such as n-propane, isopropane, n-butane, isobutane, 2,2-dimethylbutane, n-pentane, isopentane, dimethyl ether, difluoroethane, fluorotrichloromethane, dichlorodifluoromethane or dichlortetrafluoroethane, HFC 152 A or Mixtures thereof. Hydrocarbons, in particular propane, n-butane, n-pentane and mixtures thereof, and also dimethyl ether and difluoroethane are primarily used. If appropriate, one or more of the specified chlorinated hydrocarbons are co-used in propellant mixtures, but only in small amounts, for example up to 20% by weight, based on the propellant mixture. The hair cosmetic preparations according to the invention are also suitable for pump spray preparations without the addition of propellants and also for aerosol sprays with customary compressed gases such as nitrogen, compressed air or carbon dioxide as propellant.

### Surfactants

The compositions according to the invention can also comprise surfactants. Surfactants which may be used are anionic, cationic, nonionic and/or amphoteric surfactants.

Advantageous anionic surfactants for the purposes of the present invention are acylamino acids and salts thereof, such as
acyl glutamates, in particular sodium acylglutamate
sarcosinates, for example myristoyl sarcosine, TEA lauroyl sarcosinate, sodium lauroyl sarcosinate and sodium cocoyl sarcosinate,
   sulfonic acids and salts thereof, such as
acyl isethionates, for example sodium or ammonium cocoyl isethionate
sulfosuccinates, for example dioctyl sodium sulfosuccinate, disodium laureth sulfosuccinate, disodium lauryl sulfosuccinate and disodium undecylenamido MEA sulfosuccinate, disodium PEG-5 lauryl citrate sulfosuccinate and derivatives,
   and sulfuric esters, such as
alkyl ether sulfate, for example sodium, ammonium, magnesium, MIPA, TIPA laureth sulfate, sodium myreth sulfate and sodium C₁₂₋₁₃ pareth sulfate,
alkyl sulfates, for example sodium, ammonium and TEA lauryl sulfate.

Further advantageous anionic surfactants are
taurates, for example sodium lauroyl taurate and sodium methyl cocoyl taurate,
ether carboxylic acids, for example sodium laureth-13 carboxylate and sodium PEG-6 cocamide carboxylate, sodium PEG-7 olive oil carboxylate
phosphoric esters and salts, such as, for example, DEA oleth-10 phosphate and dilaureth-4 phosphate,
alkylsulfonates, for example sodium cocomonoglyceride sulfate, sodium C₁₂₋₁₄ olefinsulfonate, sodium lauryl sulfoacetate and magnesium PEG-3 cocamide sulfate,
acyl glutamates, such as Di-TEA palmitoyl aspartate and sodium caprylic/capric glutamate,
acyl peptides, for example palmitoyl hydrolyzed milk protein, sodium cocoyl hydrolyzed soybean protein and sodium/potassium cocoyl hydrolyzed collagen
   and carboxylic acids and derivatives,
   for example lauric acid, aluminum stearate, magnesium alkanolate and zinc undecylenate, ester carboxylic acids, for example calcium stearoyl lactylate, laureth-6 citrate and sodium PEG-4 lauramide carboxylate
alkylarylsulfonates.

Advantageous cationic surfactants for the purposes of the present invention are quaternary surfactants. Quaternary surfactants comprise at least one N atom which is covalently bonded to 4 alkyl or aryl groups. Alkylbetaine, alkylamidopropylbetaine and alkylamidopropylhydroxysultaine, for example, are advantageous.

Further advantageous cationic surfactants for the purposes of the present invention are also
alkylamines,
alkylimidazoles and
ethoxylated amines
   and in particular salts thereof.

Advantageous amphoteric surfactants for the purposes of the present invention are acyl-/dialkylethylenediamines, for example sodium acyl amphoacetate, disodium acyl amphodipropionate, disodium alkyl amphodiacetate, sodium acyl amphohydroxypropylsulfonate, disodium acyl amphodiacetate, sodium acyl amphopropionate, and N-coconut fatty acid amidoethyl-N-hydroxyethyl glycinate sodium salts.

Further advantageous amphoteric surfactants are N-alkylamino acids, for example aminopropylalkylglutamide, alkylaminopropionic acid, sodium alkyl imidodipropionate and lauroamphocarboxyglycinate.

Advantageous active nonionic surfactants for the purposes of the present invention are
alkanolamides, such as cocamides MEA/DEA/MIPA,
esters which are formed by esterification of carboxylic acids with ethylene oxide, glycerol, sorbitan or other alcohols,
ethers, for example ethoxylated alcohols, ethoxylated lanolin, ethoxylated polysiloxanes, propoxylated POE ethers, alkyl polyglycosides, such as laurylglucoside, decyl glycoside and cocoglycoside, glycosides with an HLB value of at least 20 (e.g. Belsil®SPG 128V (Wacker)).

Further advantageous nonionic surfactants are alcohols and amine oxides, such as cocoamidopropylamine oxide.

Among the alkyl ether sulfates, sodium alkyl ether sulfates based on di- or triethoxylated lauryl and myristyl alcohol in particular are preferred. They are significantly superior to the alkyl sulfates with regard to insensitivity toward water hardness, ability to be thickened, solubility at low temperatures and, in particular, skin and mucosa compatibility. Lauryl ether sulfate has better foaming properties than myristyl ether sulfate, but is inferior to this in terms of mildness.

Alkyl ether carboxylates with an average and particularly with a relatively high actually belong to the mildest surfactants, but exhibit poor foaming and viscosity behavior. They are often used in combination with alkyl ether sulfates and amphoteric surfactants.

Sulfosuccinic esters (sulfosuccinates) are mild and readily foaming surfactants, but, due to their poor ability to be thickened, are preferably used only together with other anionic and amphoteric surfactants and, because of their low hydrolysis stability, preferably only in neutral or well-buffered products.

Amidopropylbetaines have excellent skin and eye mucosa compatibility. In combination with anionic surfactants, their mildness can be synergistically improved. The use of cocamidopropylbetaine is preferred.

Amphoacetates/amphodiacetates are amphoteric surfactants and have very good skin and mucosa compatibility and can have a conditioning effect and increase the care effect of additives. They are used in a similar way to the betaines for optimizing alkyl ether sulfate formulations. Sodium cocoamphodiacetate and disodium cocoamphodiacetate are most preferred.

Alkyl polyglycosides are mild, have good universal properties, but are weakly foaming. For this reason, they are preferably used in combinations with anionic surfactants.

### Polysorbates

In addition, according to the invention, polysorbate agents can advantageously be incorporated into the composition.

Polysorbates advantageous for the purposes of the invention here are
polyoxyethylene(20) sorbitan monolaurate (Tween 20, CAS No. 9005-64-5)
polyoxyethylene(4) sorbitan monolaurate (Tween 21, CAS No. 9005-64-5)
polyoxyethylene(4) sorbitan monostearate (Tween 61, CAS No. 9005-67-8)
polyoxyethylene(20) sorbitan tristearate (Tween 65, CAS No. 9005-71-4)
polyoxyethylene(20) sorbitan monooleate (Tween 80, CAS No. 9005-65-6)
polyoxyethylene(5) sorbitan monooleate (Tween 81, CAS No. 9005-65-5)
polyoxyethylene(20) sorbitan trioleate (Tween 85, CAS No. 9005-70-3).

Of particular advantage are, in particular,
polyoxyethylene(20) sorbitan monopalmitate (Tween 40, CAS No. 9005-66-7)
polyoxyethylene(20) sorbitan monostearate (Tween 60, CAS No. 9005-67-8).

According to the invention, these are advantageously used in a concentration of from 0.1 to 5% by weight and in particular in a concentration of from 1.5 to 2.5% by weight, based on the total weight of the composition individually or as a mixture of two or more polysorbates.

In one embodiment of the invention, the compositions according to the invention comprise copolymer a) and, in each case based on the composition, less than 1% by weight of, preferably less than 0.1% by weight of and in particular no oligomer b).

The cosmetic compositions according to the invention comprising copolymer a) can be used advantageously for removing excess oil or lipid from the surface of the skin. In particular, these compositions comprise, based on the composition, less than 1% by weight of, preferably less than 0.1% by weight of and in particular no oligomer b).

### Self-Tanning Products

Standard commercial self-tanning products are generally O/W emulsions. In these, the water phase is stabilized by emulsifiers customary in cosmetics. The required additional stabilization through carbomers is disadvantageous. Their use in conjunction with self-tanning agents, in particular with dihydroxyacetone (DHA) leads, as a result of chemical reaction, to a yellowish discoloration of the preparation and to odor impairments. One alternative to using carbomers is to use xanthan gum. Although this gives stable products, an unpleasant sticky feel on the skin has to often be accepted.

It was thus a further object of the present invention to provide self-tanning products which do not have the abovementioned disadvantages.

Surprisingly, this object was achieved by compositions according to the invention which comprise one or more self-tanning substances.

Accordingly, the invention also provides cosmetic compositions comprising copolymer a), if appropriate mixed with oligomer b), one or more self-tanning substances and, if appropriate, further cosmetic and/or dermatological active ingredients, auxiliaries and additives.

The compositions according to the invention can be present and used in various forms.

Thus they may form, for example, an emulsion of the oil-in-water (O/W) type or a multiple emulsion, for example of the water-in-oil-in-water (W/O/W) type. Emulsifier-free formulations, such as hydrodispersions, hydrogels or a Pickering emulsion are also advantageous embodiments.

The consistency of the formulations can range from pasty formulations via flowable formulations to low viscosity sprayable products. Accordingly, creams, lotions or sprays can be formulated. For use, the cosmetic compositions according to the invention are applied to the skin in the manner customary for cosmetics and dermatological products in a sufficient amount.

Through the use it is possible not only to achieve an even skin color, it is also possible to color areas of skin which are differently colored as a result of nature or as a result of pathological change.

The self-tanning agents used advantageously according to the invention are, inter alia, glycerol aldehyde, hydroxymethylglyoxal, γ-dialdehyde, erythrulose, 5-hydroxy-1,4-naphthoquinone (Jug ion), and 2-hydroxy-1,4-naphthoquinone which occurs in henna leaves.

For the purposes of the invention, very particular preference is given to 1,3-dihydroxy-acetone (DHA), a trivalent sugar which occurs in the human body. 6-Aldo-D-fructose and ninhydrin can also be used as self-tanning agents according to the invention. For the purposes of the invention, self-tanning agents are also understood as meaning substances which bring about a skin color which departs from a brown shade.

In a preferred embodiment of the invention, these compositions comprise two or more self-tanning substances in a concentration of from 0.1 to 10% by weight and particularly preferably from 0.5 to 6% by weight, in each case based on the total weight of the composition.

Preferably, these compositions comprise 1,3-dihydroxyacetone as self-tanning substance. Further preferably, these compositions comprise organic and/or inorganic photoprotective filters. The compositions can also comprise inorganic and/or organic and/or modified inorganic pigments.

Customary and advantageous ingredients also present in the compositions according to the invention are specified above and, for example, in DE 103 21 147 in paragraphs [0024] to [0132], which is hereby incorporated in its entirety at this point by reference.

The invention also provides the use of such compositions for coloring the skin of multicellular organisms, in particular the skin of humans and animals, in particular also for evening out the color of areas of skin that are pigmented to differing degrees.

### EXAMPLES

The invention is illustrated by examples.

Unless stated otherwise, all of the reactions were carried out under an atmosphere of nitrogen.

The K values of the copolymers according to the invention were determined in accordance with H. Fikentscher, Cellulose-Chemie [Cellulose chemistry], Volume 13, 58-64 and 761-774 (1932) in cyclohexanone at 25° C. and a polymer concentration of 2% by weight.

### Preparation Procedure for Copolymer a)

206 g of polyisobutene with a molecular weight Mₙ of 550 g/mol and 185 g of diisobutene (mixture of 2,4,4-trimethyl-1-pentene and 2,4,4-trimethyl-2-pentene in a molar ratio of 80:20, determined by ¹H NMR spectroscopy) were initially introduced into a 4 l reactor and heated to 110° C. in a gentle stream of nitrogen. After reaching a temperature of 110° C., 184 g of maleic anhydride in liquid form as melt at about 70° C. were metered in over the course of 5 hours, and 5.5 g of tert-butyl peroctoate, dissolved in 25 g of diisobutene (mixture of 2,4,4-trimethyl-1-pentene and 2,4,4-trimethyl-2-pentene) were metered in over the course of 5.5 hours. The mixture was then after-heated for one hour at 120° C. The temperature was then increased to 160° C. and unreacted diisobutene was distilled off.

The resulting reaction mixture was cooled to 90° C. and at the same time admixed with 2400 g of water and 140 g of 50% strength by weight aqueous sodium hydroxide solution. The mixture was then stirred for 4 hours at 90° C. and then cooled to room temperature. This gave copolymer a) in the form of an aqueous dispersion which had a pH of 6.5 and a water content of 80% by weight. The K value was 14.7.

### Mixing of Copolymer a) and Oligomer b)

### Mixture 1:

A first mixture of copolymer a) with oligomer b) is prepared by mixing 90 g of polyisobutene (oligomer b)) with a molecular weight Mₙ of 550 g/mol with 10 g of the above-described dispersion of copolymer a) by stirring in a beaker.

### Mixture 2:

A second mixture of copolymer a) with oligomer b) is prepared by mixing 90 g of polyisobutene (oligomer b)) with a molecular weight Mₙ of 1000 g/mol with 10 g of the above-described dispersion of copolymer a) by stirring in a beaker.

This gave then two mixtures of copolymer a) and oligomer b) suitable for the use according to the invention.

### Application Examples

Mixtures 1 and/or 2 described above are used to prepare the compositions specified below. Unless information is given to the contrary, the quantitative amounts are in each case in % by weight.

The amount of mixture 1 and mixture 2 given in the tables is in each case the amount of copolymer a), i.e. without other components. The corresponding amount of oligomer b) is not given in the tables, but can be easily calculated from the compositions of the mixtures.

Gel cream:

| | 1 | 2 | 3 | 4 |
|---|---|---|---|---|
| Acrylate/C10-30 alkyl acrylate | 0.40 | 0.35 | 0.40 | 0.35 |
| crosspolymer | | | | |
| Polyacrylic acid | 0.20 | 0.22 | 0.20 | 0.22 |
| Luvigel ® EM | 1.50 | 2.50 | 2.80 | 3.50 |
| Xanthan gum | 0.10 | 0.13 | 0.10 | 0.13 |
| Cetearyl alcohol | 3.00 | 2.50 | 3.00 | 2.50 |
| C12-15 Alkyl benzoate | 4.00 | 4.50 | 4.00 | 4.50 |
| Caprylic/capric triglyceride | 3.00 | 3.50 | 3.00 | 3.50 |
| Titanium dioxide - microfine | 1.00 | | 1.50 | |
| Zinc oxide - microfine | | 2.00 | | 0.25 |
| Mixture 1 | 2.00 | 5.00 | | |
| Mixture 2 | | | 4.00 | 8.00 |
| Dihydroxyacetone | | | 3.00 | 5.00 |
| Cyclic dimethylpolysiloxane | 5.00 | 5.50 | 5.00 | 5.50 |
| Dimethicone polydimethylsiloxane | 1.00 | 0.60 | 1.00 | 0.60 |
| Glycerol | 1.00 | 1.20 | 1.00 | 1.20 |
| Sodium hydroxide | q.s. | q.s. | q.s. | q.s. |
| Preservative | 0.30 | 0.23 | 0.30 | 0.23 |
| Perfume | 0.20 | | 0.20 | |
| Water | ad 100 | ad 100 | ad 100 | ad 100 |
| pH adjusted to 6.0 | | | | |

Cosmetic O/W formulations:

| | 1 | 2 | 3 | 4 | 5 | 6 | 7 |
|---|---|---|---|---|---|---|---|
| Glycerol monostearate SE | 0.50 | 1.00 | 3.00 | | | 1.50 | |
| Glyceryl stearate citrate | 2.00 | | 1.00 | 2.00 | 4.00 | | |
| Stearic acid | | 3.00 | | 2.00 | | | |
| PEG-40 stearate | 0.50 | | | | | 2.00 | |
| Cetyl phosphate | | | | | | 1.00 | |
| Cetearyl sulfate | | | | | | | 0.75 |
| Stearyl alcohol | | | 3.00 | | | 2.00 | 0.60 |
| Cetyl alcohol | 2.50 | 1.10 | | 1.50 | 0.60 | | 2.00 |
| Mixture 1 | 2.00 | 5.00 | 7.00 | | | | 1.00 |
| Mixture 2 | | | | 10.00 | 8.00 | 5.00 | 1.00 |
| Dihydroxyacetone | | | 3.00 | 5.00 | | 3.00 | |
| Titanium dioxide - microfine | 1.00 | | | | 1.50 | | 1.50 |
| Zinc oxide - microfine | | | | 0.25 | | 2.00 | |
| C12-15 Alkyl benzoate | | 0.25 | | | 4.00 | 7.00 | |
| Dicapryl ether | | | 3.50 | | 2.00 | | |
| Butylene glycol | 5.00 | | 6.00 | | | | |
| dicaprylate/dicaprate | | | | | | | |
| Cocoglycerides | | | 6.00 | | 2.00 | | |
| Dimethicone | 0.50 | | 1.00 | | 2.00 | | |
| Cyclomethicone | 2.00 | | 0.50 | | 0.50 | | |
| Shea butter | | 2.00 | | | | | |
| PVP hexadecene copolymer | 0.20 | | | 0.50 | | 1.00 | |
| Glycerol | 3.00 | 7.50 | | 7.50 | 5.00 | | 2.50 |
| Xanthan gum | 0.15 | | 0.05 | | | 0.30 | |
| Sodium carbomer | | 0.20 | | 0.15 | 0.25 | | |
| Vitamin E acetate | 0.60 | | 0.23 | | 0.70 | 1.00 | |
| Fucogel ® 1000 | | 3.00 | 10.00 | | | | |
| Glycine soya | | | | 0.50 | | 1.50 | 1.00 |
| Ethylhexyloxyglycine | 0.30 | | | | | | |
| DMDM hydantoin | | 0.60 | 0.40 | 0.20 | | | |
| Glyacil-L ® | | | | 0.18 | 0.20 | | |
| Methylparaben | 0.15 | | 0.25 | | 0.50 | | |
| Phenoxyethanol | 1.00 | 0.40 | | | 0.40 | 0.50 | 0.40 |
| Trisodium EDTA | 0.02 | | 0.05 | | | | |
| Iminosuccinic acid | | | | 0.25 | 1.00 | | |
| Ethanol | 2.00 | 1.50 | | 3.00 | | 1.20 | 5.00 |
| Perfume | 0.10 | 0.25 | 0.30 | | 0.40 | 0.20 | |
| Water | ad 100 | ad 100 | ad 100 | ad 100 | ad 100 | ad 100 | ad 100 |

Cosmetic hydrodispersion formulations:

| | 1 | 2 | 3 | 4 | 5 |
|---|---|---|---|---|---|
| Ceteaereth-20 | 1.00 | | | 0.50 | |
| Cetyl alcohol | | | 1.00 | | |
| Luvigel ® EM | | 2.00 | | 2.50 | 2.00 |
| Acrylate/C10-30 alkyl | 0.50 | | 0.40 | 0.10 | 0.50 |
| acrylate crosspolymer | | | | | |
| Xanthan gum | | 0.30 | 0.15 | | |
| Mixture 1 | 3.00 | 6.00 | 2.00 | | |
| Mixture 2 | | | 2.00 | 4.00 | 7.00 |
| Dihydroxyacetone | | | 3.00 | 5.00 | |
| Titanium dioxide - | 1.00 | | 1.00 | | 1.00 |
| microfine | | | | | |
| Zinc oxide - microfine | | 1.90 | | 0.25 | |
| C12-15 Alkyl benzoate | 2.00 | 2.50 | | | |
| Dicapryl ether | | 4.00 | | | |
| Butylene glycol | 4.00 | | 2.00 | 6.00 | |
| dicaprylate/ dicaprate | | | | | |
| Dicapryl carbonate | | 2.00 | 6.00 | | |
| Dimethicone | | 0.50 | 1.00 | | |
| Phenyltrimethicone | 2.00 | | 0.50 | | |
| Shea butter | | 2.00 | | 5.00 | |
| PVP hexadecene | 0.50 | | | 0.50 | 1.00 |
| copolymer | | | | | |
| Tricontanyl PVP | 0.50 | | 1.00 | | |
| Ethylhexylglycerol | | | 1.00 | | 0.80 |
| Glycerol | 3.00 | 7.50 | | 7.50 | 8.50 |
| Glycine soya | | | 1.50 | | 1.00 |
| Vitamin E acetate | 0.50 | | 0.25 | | 1.00 |
| Alpha-glucosylrutin | 0.60 | | | 0.25 | |
| DMDM hydantoin | | 0.60 | 0.45 | 0.25 | |
| Glyacil-S ® | 0.20 | | | | |
| Methylparaben | 0.50 | | 0.25 | 0.15 | |
| Phenoxyethanol | 0.50 | 0.40 | | 1.00 | |
| Trisodium EDTA | | 0.01 | 0.05 | | 0.10 |
| Ethanol | 3.00 | 2.00 | 1.50 | | 7.00 |
| Perfume | 0.20 | | 0.05 | 0.40 | |
| Water | ad 100 | ad 100 | ad 100 | ad 100 | ad 100 |

Cosmetic W/O formulations:

| | 1 | 2 | 3 | 4 | 5 |
|---|---|---|---|---|---|
| Cetyldimethicone | | 2.50 | | 4.00 | |
| copolyol | | | | | |
| Polyglyceryl-2 | 5.00 | | | | 4.50 |
| dipolyhydroxystearate | | | | | |
| PEG-30 | | | 5.00 | | |
| dipolyhydroxystearate | | | | | |
| Mixture 1 | 2.00 | 3.00 | 5.00 | | |
| Mixture 2 | 1.00 | | | 3.00 | 9.00 |
| Titanium dioxide - | 1.00 | | 3.00 | | 3.50 |
| microfine | | | | | |
| Zinc oxide - microfine | | 0.90 | | 0.25 | |
| Mineral oil | | 12.00 | 10.00 | | 8.00 |
| C12-15 Alkyl benzoate | | | | 9.00 | |
| Dicaprylyl ether | 10.00 | | | | 7.00 |
| Butylene glycol | | | 2.00 | 8.00 | 4.00 |
| dicaprylate/dicaprate | | | | | |
| Dicaprylyl carbonate | 5.00 | | 6.00 | | |
| Dimethicone | | 4.00 | 1.00 | 5.00 | |
| Cyclomethicone | 2.00 | 25.00 | | | 2.00 |
| Shea butter | | | 3.00 | | |
| Vaseline | | 4.50 | | | |
| PVP Hexadecene | 0.50 | | | 0.50 | 1.00 |
| copolymer | | | | | |
| Ethylhexylglycererol | | 0.30 | 1.00 | | 0.50 |
| Glycerol | 3.00 | 7.50 | | 7.50 | 8.50 |
| Glycine soya | | 1.00 | 1.50 | | 1.00 |
| MgSO4 | 1.00 | 0.50 | | 0.50 | |
| MgCl2 | | | 1.00 | | 0.70 |
| Vitamin E acetate | 0.50 | | 0.25 | | 1.00 |
| Ascorbyl palmitate | 0.50 | | | 2.00 | |
| DMDM hydantoin | | 0.60 | 0.40 | 0.20 | |
| Methylparaben | 0.50 | | 0.25 | 0.15 | |
| Phenoxyethanol | 0.50 | 0.40 | | 1.00 | |
| Trisodium EDTA | 0.12 | 0.05 | | 0.30 | |
| Ethanol | 3.00 | | 1.50 | | 5.00 |
| Perfume | 0.20 | | 0.40 | 0.35 | |
| Water | ad 100 | ad 100 | ad 100 | ad 100 | ad 100 |

Solids-stabilized formulations:

| | 1 | 2 | 3 | 4 | 5 |
|---|---|---|---|---|---|
| Mineral oil | | | 16.00 | 16.00 | |
| Octyldodecanol | 9.00 | 9.00 | 5.00 | | |
| Caprylic/capric triglyceride | 9.00 | 9.00 | 6.00 | | |
| C12-15 Alkyl benzoate | | | | 5.00 | 8.00 |
| Butylene glycol dicaprylate/dicaprate | | | | | 8.00 |
| Dicaprylyl ether | 9.00 | | | 4.00 | |
| Dicaprylyl carbonate | | 9.00 | | | |
| Hydroxyoctacosanyl hydroxystearate | 2.00 | 2.00 | 2.20 | 2.50 | 1.50 |
| Disteardimonium hectorite | 1.00 | 0.75 | | 0.50 | 0.25 |
| Cera Microcristallina + Paraffinum | | 0.35 | | | 5.00 |
| Liquidum | | | | | |
| Hydroxypropylmethylcellulose | | | 0.10 | | 0.05 |
| Dimethicone | | | | | 3.00 |
| Mixture 1 | 3.00 | 5.00 | | | 2.00 |
| Mixture 2 | | | 5.00 | 3.00 | 4.00 |
| Titanium dioxide + alumina + | | 3.00 | | | |
| simethicone + Aqua | | | | | |
| Titanium dioxide + | | 2.00 | 4.00 | 2.00 | 4.00 |
| trimethoxycaprylylsilane | | | | | |
| Silica dimethyl silylate | 2.50 | | | 6.00 | 2.50 |
| Boron nitride | | | 1.00 | | |
| Starch/sodium metaphosphate | 2.00 | | | | |
| polymer | | | | | |
| Tapioca starch | | 0.50 | | | |
| Sodium chloride | 5.00 | 7.00 | 8.50 | 3.00 | 4.50 |
| Glycerol | | | | 1.00 | |
| Trisodium EDTA | 1.00 | 1.00 | 1.00 | 1.00 | 1.00 |
| Vitamin E acetate | 5.00 | 10.00 | 3.00 | 6.00 | 10.00 |
| Ascorbyl palmitate | 1.00 | 1.00 | | 1.00 | |
| Methylparaben | | 0.60 | | | 0.20 |
| Propylparaben | | | | | 0.20 |
| Phenoxyethanol | | | 0.20 | | |
| Hexamidine diisethionate | | | 0.40 | 0.50 | 0.40 |
| Diazolidinylurea | | | | | 0.08 |
| Ethanol | | | 0.23 | 0.20 | |
| Perfume | 5.00 | | 3.00 | 4.00 | |
| Water | 0.20 | | 0.30 | 0.10 | |

Cosmetic stick formulations:

| | 1 | 2 | 3 | 4 |
|---|---|---|---|---|
| Caprylic/capric triglyceride | 12.00 | 10.00 | 6.00 | |
| Octyldodecanol | 7.00 | 14.00 | 8.00 | 3.00 |
| Butylene glycol dicaprylate/ | | | | 12.00 |
| dicaprate | | | | |
| Pentaerythrityl tetraisostearate | 10.00 | 6.00 | 8.00 | 7.00 |
| Polyglyceryl-3 diisostearate | 2.50 | | | |
| Bis-diglyceryl polyacyl adipate-2 | 9.00 | 8.00 | 10.00 | 8.00 |
| Cetearyl alcohol | 8.00 | 11.00 | 9.00 | 7.00 |
| Myristyl myristate | 3.50 | 3.00 | 4.00 | 3.00 |
| Beeswax | 5.00 | 5.00 | 6.00 | 6.00 |
| Cera Carnauba | 1.50 | 2.00 | 2.00 | 1.50 |
| Cera Alba | 0.50 | 0.50 | 0.50 | 0.40 |
| C16-40 alkyl stearate | | 1.50 | 1.50 | 1.50 |
| Mixture 1 | 2.00 | 3.00 | | 12.00 |
| Mixture 2 | 2.00 | | 4.00 | |
| Titanium dioxide - microfine | 1.00 | | 3.00 | |
| Zinc oxide - microfine | | 1.00 | | 0.25 |
| Vitamin E acetate | 0.50 | 1.00 | | |
| Ascorbyl palmitate | 0.05 | | 0.05 | |
| Buxux Chinensis | 2.00 | 1.00 | | 1.00 |
| Perfume, BHT | 0.10 | 0.25 | | 0.35 |
| Ricinus Communis | ad 100 | ad 100 | ad 100 | ad 100 |

Cosmetic PIT formulations:

| | 1 | 2 | 3 | 4 | 5 | 6 | 7 | 8 |
|---|---|---|---|---|---|---|---|---|
| Glycerol monostearate SE | 0.50 | 2.00 | 3.00 | 5.00 | | 0.50 | 4.00 | |
| Glyceryl isostearate | | | | | 3.50 | 4.00 | 2.00 | |
| Isoceteth-20 | | 0.50 | | | 2.00 | | | |
| Ceteareth-12 | | 5.00 | | 1.00 | | | 3.50 | 5.00 |
| Ceteareth-20 | | 5.00 | | 1.00 | | | | 3.50 |
| PEG-100 stearate | | | | 2.80 | | 2.30 | 3.30 | |
| Cetyl alcohol | 5.20 | | 1.20 | 1.00 | 1.30 | | 0.50 | 0.30 |
| Cetyl palmitate | 2.50 | 1.20 | | 1.50 | | 0.50 | | 1.50 |
| Cetyl dimethicone copolyol | | | | 0.50 | | 1.00 | | |
| Polyglyceryl-2 | | | | 0.75 | 0.30 | | | |
| Mixture 1 | 2.00 | 5.00 | 7.90 | 15.00 | 1.00 | | | |
| Mixture 2 | | | | | 6.00 | 5.00 | 9.00 | 3.50 |
| Dihydroxyacetone | | | 3.00 | 5.00 | | | 4.00 | |
| Titanium dioxide - microfine | 1.00 | | 1.50 | | 3.50 | | 1.50 | 1.00 |
| Zinc oxide - microfine | | 1.00 | | 0.25 | | 2.00 | | 1.50 |
| C12-15 Alkyl benzoate | 3.50 | | | 6.35 | | | | 0.10 |
| Cocoglycerides | | 3.00 | | 3.00 | | | | 1.00 |
| Dicapryl ether | 4.50 | | | | | | | |
| Dicaprylyl carbonate | | 4.30 | | 3.00 | | | | 7.00 |
| Dibutyl adipate | | | | 0.50 | | | | 0.30 |
| Phenyltrimethicone | 2.00 | | | 3.50 | | 2.00 | | |
| Cyclomethicone | | 3.00 | | | | | | |
| Ethyl galactomannan | | 0.50 | | | 2.00 | | | |
| Hydrogenated cocoglycerides | | | | | 3.00 | 4.00 | | |
| Abil Wax 2440 | | | | | | 1.50 | 2.00 | |
| PVP hexadecene copolymer | | | | 1.00 | 1.20 | | | |
| Glycerol | 4.00 | 6.00 | 5.00 | | 8.00 | 10.00 | | |
| Vitamin E acetate | 0.20 | 0.30 | 0.40 | | 0.30 | | | |
| Shea butter | | 2.00 | | 3.60 | | 2.00 | | |
| Iodopropyl butylcarbamate | 0.12 | | | | 0.20 | | | |
| DMDM hydantoin | 0.10 | | | | 0.12 | | 0.13 | |
| Methylparaben | | 0.50 | 0.30 | | 0.35 | | | |
| Phenoxyethanol | 0.50 | 0.40 | | 1.00 | | | | |
| Octoxyglycerol | | 0.30 | | | 1.00 | | 0.35 | |
| Ethanol | 2.00 | | 2.00 | | | 5.00 | | |
| Trisodium EDTA | 0.40 | | 0.15 | | | 0.20 | | |
| Perfume | 0.20 | | 0.20 | | 0.24 | 0.16 | 0.10 | 0.10 |
| Water | ad 100 | ad 100 | ad 100 | ad 100 | ad 100 | ad 100 | ad 100 | ad 100 |

Cosmetic oils and oil gels

| | 1 | 2 | 3 | 4 |
|---|---|---|---|---|
| Caprylic/capric triglyceride | 12.00 | 10.00 | 6.00 | |
| Octyldodecanol | 7.00 | 14.00 | 8.00 | 3.00 |
| Butylene glycol | | | | 12.00 |
| dicaprylate/dicaprate | | | | |
| Pentaerythrityl tetraisostearate | 10.00 | 6.00 | 8.00 | 7.00 |
| Polyglyceryl-3 diisostearate | 2.50 | | | |
| Bis-diglyceryl polyacyladipate-2 | 9.00 | 8.00 | 10.00 | 8.00 |
| Myristyl myristate | 3.50 | 3.00 | 4.00 | 3.00 |
| Bentone-34 | 5.00 | 5.00 | 6.00 | 6.00 |
| Propylene carbonate | 15.00 | 20.00 | 18.00 | 19.50 |
| Mixture 1 | 2.00 | 3.00 | | 12.00 |
| Mixture 2 | 2.00 | | 4.00 | |
| Vitamin E acetate | 0.50 | 1.00 | | |
| Ascorbyl palmitate | 0.05 | | 0.05 | |
| Buxux Chinensis | 2.00 | 1.00 | | 1.00 |
| Perfume, BHT | 0.10 | 0.25 | | 0.35 |
| Ricinus Communis | ad 100 | ad 100 | ad 100 | ad 100 |

Cosmetic aftersun formulations:

| | 1 | 2 | 3 | 4 | 5 |
|---|---|---|---|---|---|
| Ceteaereth-20 | 1.00 | | | 0.50 | |
| Cetyl alcohol | | | 1.00 | | |
| Luvigel ® EM | | 2.00 | | 2.50 | 2.00 |
| Acrylate/C10-30 alkyl | 0.50 | 0.30 | 0.40 | 0.10 | 0.50 |
| acrylate crosspolymer | | | | | |
| Xanthan gum | | 0.30 | 0.15 | | |
| Mixture 1 | 3.00 | 6.00 | 2.00 | | |
| Mixture 2 | | | 2.00 | 4.00 | 7.00 |
| C12-15 Alkyl benzoate | 2.00 | 2.50 | | | |
| Dicapryl ether | | 4.00 | | | |
| Butyleneglycol | 4.00 | | 2.00 | 6.00 | |
| dicaprylate/dicaprate | | | | | |
| Dicapryl carbonate | | 2.00 | 6.00 | | |
| Dimethicone | | 0.50 | 1.00 | | |
| Phenyltrimethicone | 2.00 | | 0.50 | | |
| Tricontanyl PVP | 0.50 | | 1.00 | | |
| Ethylhexylglycerol | | | 1.00 | | 0.80 |
| Glycerol | 3.00 | 7.50 | | 7.50 | 8.50 |
| Glycine soya | | | 1.50 | | 1.00 |
| Vitamin E acetate | 0.50 | | 0.25 | | 1.00 |
| Alpha-glucosylrutin | 0.60 | | | 0.25 | |
| Trisodium EDTA | | 0.01 | 0.05 | | 0.10 |
| Ethanol | 15.00 | 10.00 | 8.00 | 12.00 | 9.00 |
| Perfume | 0.20 | | 0.05 | 0.40 | |
| Water | ad 100 | ad 100 | ad 100 | ad 100 | ad 100 |

Cosmetic formulations for decorative cosmetics:

| | 1 | 2 | 3 | 4 | 5 | 6 | 7 |
|---|---|---|---|---|---|---|---|
| Glycerol monostearate SE | 0.50 | 1.00 | 3.00 | | | 1.50 | |
| Glyceryl stearate citrate | 2.00 | | 1.00 | 2.00 | 4.00 | | |
| Stearic acid | | 3.00 | | 2.00 | | | |
| PEG-40 stearate | 0.50 | | | | | 2.00 | |
| Cetyl phosphate | | | | | | 1.00 | |
| Cetearyl sulfate | | | | | | | 0.75 |
| Stearyl alcohol | | | 3.00 | | | 2.00 | 0.60 |
| Cetyl alcohol | 2.50 | 1.10 | | 1.50 | 0.60 | | 2.00 |
| Mixture 1 | 2.00 | 5.00 | 7.00 | | | | 1.00 |
| Mixture 2 | | | | 10.00 | 8.00 | 5.00 | 1.00 |
| Titanium dioxide | 10.00 | 12.00 | 9.00 | 8.50 | 11.00 | 9.50 | 10.00 |
| Iron oxides | 2.00 | 4.00 | 3.00 | 5.00 | 3.40 | 6.00 | 4.40 |
| Zinc oxide | | 4.00 | | 2.00 | | 3.00 | |
| C12-15 Alkyl benzoate | | 0.25 | | | 4.00 | 7.00 | |
| Dicapryl ether | | | 3.50 | | 2.00 | | |
| Butylene glycol | 5.00 | | 6.00 | | | | |
| dicaprylate/dicaprate | | | | | | | |
| Cocoglycerides | | | 6.00 | | 2.00 | | |
| Dimethicone | 0.50 | | 1.00 | | 2.00 | | |
| Cyclomethicone | 2.00 | | 0.50 | | 0.50 | | |
| Shea butter | | 2.00 | | | | | |
| PVP hexadecene copolymer | 0.20 | | | 0.50 | | 1.00 | |
| Glycerol | 3.00 | 7.50 | | 7.50 | 5.00 | | 2.50 |
| Xanthan gum | 0.15 | | 0.05 | | | 0.30 | |
| Sodium carbomer | | 0.20 | | 0.15 | 0.25 | | |
| Vitamin E acetate | 0.60 | | 0.23 | | 0.70 | 1.00 | |
| Glycine soya | | | | 0.50 | | 1.50 | 1.00 |
| Ethylhexyloxyglycine | 0.30 | | | | | | |
| DMDM hydantoin | | 0.60 | 0.40 | 0.20 | | | |
| Glyacil-L ® | | | | 0.18 | 0.20 | | |
| Methylparaben | 0.15 | | 0.25 | | 0.50 | | |
| Phenoxyethanol | 1.00 | 0.40 | | | 0.40 | 0.50 | 0.40 |
| Trisodium EDTA | 0.02 | | 0.05 | | | | |
| Iminosuccinic acid | | | | 0.25 | 1.00 | | |
| Ethanol | 2.00 | 1.50 | | 3.00 | | 1.20 | 5.00 |
| Perfume | 0.10 | 0.25 | 0.30 | | 0.40 | 0.20 | |
| Water | ad 100 | ad 100 | ad 100 | ad 100 | ad 100 | ad 100 | ad 100 |

Foam-like formulations:

| | Emulsion 1 | | Emulsion 2 | |
|---|---|---|---|---|
| | | % by | | % by |
| | % by wt. | vol. | % by wt. | vol. |
| Stearic acid | 5.00 | | 1.00 | |
| Cetyl alcohol | 5.50 | | | |
| Cetylstearyl alcohol | | | 2.00 | |
| PEG-40 stearate | 8.50 | | | |
| PEG-20 stearate | | | 1.00 | |
| Caprylic/capric triglycerides | 4.00 | | 2.00 | |
| C12-15 Alkyl benzoate | 10.00 | | 15.00 | |
| Cyclomethicone | 4.00 | | | |
| Dimethicone | | | 0.50 | |
| Mixture 1 | 1.00 | | | |
| Mixture 2 | 1.00 | | | |
| Octyl isostearate | | | 5.00 | |
| Myristyl myristate | | | 2.00 | |
| Ceresin | 1.50 | | | |
| Glycerol | | | 3.00 | |
| Filter | | | | |
| Hydroxypropyldistarch phosphate | 1.00 | | 3.50 | |
| BHT | | | 0.02 | |
| Disodium EDTA | 0.50 | | 0.10 | |
| Perfume, preservative | q.s. | | q.s. | |
| Dyes | q.s. | | q.s. | |
| Potassium hydroxide | q.s. | | q.s. | |
| Water | ad 100 | | ad 100 | |

| | |
|---|---|
| pH adjusted to | adjust pH to |
| 6.5-7.5 | 5.0-6.0 |

| | | |
|---|---|---|
| Emulsion 1 | 70 | |
| Emulsion 2 | | 35 |
| Gas (nitrogen) | 30 | |
| Gas (helium) | | 65 |

### Example H1

| VOC 80 aerosol hairspray | [%] |
|---|---|
| Mixture 1 or Mixture 2 | 2.00 |
| Water | 18.00 |
| Dimethyl ether | 40.00 |
| Ethanol | 40.00 |
| Further additive: silicone, perfume, antifoam . . . | |

### Example H2

| VOC 55 aerosol hairspray | [%] |
|---|---|
| Mixture 2 or mixture 1 | 2.00 |
| Water | 33.00 |
| Dimethyl ether | 40.00 |
| Ethanol | 25.00 |
| Further additive: silicone, perfume, antifoam . . . | |

### Example H3

| VOC 55 aerosol hairspray | [%] |
|---|---|
| Mixture 1 or mixture 2 | 6.00 |
| Water | 39.00 |
| HFC 152A | 40.00 |
| Ethanol | 15.00 |
| Further additive: silicone, perfume, antifoam . . . | |

### Example H4

| VOC 55 aerosol hairspray | [%] |
|---|---|
| Mixture 1 or mixture 2 | 5.00 |
| Ultrahold ® Strong (BASF) | 1.00 |
| Water | 39.00 |
| Dimethyl ether | 40.00 |
| Ethanol | 15.00 |
| AMP | to pH 8.3 |
| Further additive: silicone, perfume, antifoam . . . | |

### Example H5

| VOC 55 aerosol hairspray | [%] |
|---|---|
| Mixture 1 or mixture 2 | 4.00 |
| Stepanhold ® R-1*⁾ (Stepan Chemical Co.) | 1.00 |
| Water | 40.00 |
| Dimethyl ether | 40.00 |
| Ethanol | 15.00 |
| +AMP | to pH 8.3 |
| Further additive: silicone, perfume, antifoam . . . | |

*⁾Stepanhold R-1 = Poly(vinylpyrrolidone/ethyl methacrylate/methacrylic acid)

### Example H6

| VOC 55 hand pump spray | [%] |
|---|---|
| Mixture 2 or mixture 1 | 4.00 |
| Water | 41.00 |
| Ethanol | 55.00 |
| Further additive: silicone, perfume, antifoam . . . | |

### Example H7

| Aqueous hand pump spray | [%] |
|---|---|
| Mixture 1 or Mixture 2 | 5.00 |
| Luviset ® Clear*⁾ (20% strength solution) | 5.00 |
| Water | 90.00 |
| Further additive: water-soluble silicone, perfume, antifoam . . . | |

*⁾Luviset Clear: poly(vinylpyrrolidone/methacrylamide/vinylimidazole), BASF

### Example H8

| | |
|---|---|
| Hair gel with Aculyn 28: | [%] |

Phase 1:

| | |
|---|---|
| Mixture 1 or mixture 2 | 6.00 |
| Water, dist. | 43.00 |
| AMP (38% strength solution) | 1.0 |
| Further additive: preservative, soluble ethoxylated silicone, | |
| perfume . . . | |

Phase 2:

| | |
|---|---|
| Aculyn ® 28 (1% strength aqueous suspension) | 50.00 |

### Preparation:

Phases 1 and 2 are weighed in separately and homogenized. Phase 2 is then slowly stirred into Phase 1. An essentially clear, stable gel is formed.

### Example S9

### Liquid Makeup

A

| | |
|---|---|
| 1.70 | Glyceryl stearate |
| 1.70 | Cetyl alcohol |
| 1.70 | Ceteareth-6 |
| 1.70 | Ceteareth-25 |
| 5.20 | Caprylic/capric triglyceride |
| 5.20 | Mineral oil |

B

| | |
|---|---|
| q.s. | Preservative |
| 4.30 | Propylene glycol |
| 2.50 | Mixture 2 or mixture 1 |
| 59.50 | Dist. water |

C

| | |
|---|---|
| q.s. | Perfume oil |

D

| | |
|---|---|
| 2.00 | Iron oxide |
| 12.00 | Titanium dioxide |

### Preparation:

Heat Phase A and Phase B separately to 80° C. Then mix Phase B into Phase A using a stirrer. Allow everything to cool to 40° C. and add Phase C and Phase D. Homogenize again.

### Example S10

### Oil-Free Makeup

A

| | |
|---|---|
| 0.35 | Veegum |
| 5.00 | Butylene glycol |
| 0.15 | Xanthan gum |

B

| | |
|---|---|
| 44.0 | Dist. water |
| q.s. | Preservative |
| 0.2 | Polysorbate-20 |
| 1.6 | Tetrahydroxypropylethylenediamine |

C

| | |
|---|---|
| 1.0 | Silicon dioxide |
| 2.0 | Nylon-12 |
| 4.15 | Mica |
| 6.0 | Titanium dioxide |
| 1.85 | Iron oxide |

D

| | |
|---|---|
| 4.0 | Stearic acid |
| 1.5 | Glyceryl stearate |
| 7.0 | Benzyl laurate |
| 5.0 | Isoeicosane |
| q.s. | Preservative |

E

| | |
|---|---|
| 0.5 | Panthenol |
| 0.1 | Imidazolidinylurea |
| 15.0 | Mixture 1 or mixture 2 |

### Preparation:

Wet Phase A with butylene glycol, add to Phase B and mix well. Heat Phase AB to 75° C. Pulverize Phase C feed substances, add to Phase AB and homogenize well. Mix feed substances of Phase D, heat to 80° C. and add to Phase ABC. Mix for some time until everything is homogeneous. Transfer everything to a vessel fitted with propeller mixer. Mix feed substances of Phase E, add to Phase ABCD and mix well.

### Example S11

### Face Mask

Phase A

| | |
|---|---|
| 3.00 | Ceteareth-6 |
| 1.50 | Ceteareth-25 |
| 5.00 | Cetearyl alcohol |
| 6.00 | Cetearyl octanoate |
| 6.00 | Mineral oil |
| 0.20 | Bisabolol |
| 3.00 | Glyceryl stearate |

Phase B

| | |
|---|---|
| 2.00 | Propylene glycol |
| 5.00 | Panthenol |
| 4.00 | Mixture 2 or mixture 1 |
| q.s. | Preservative |
| 63.80 | Dist. water |

Phase C

| | |
|---|---|
| q.s. | Perfume oil |
| 0.50 | Tocopheryl acetate |

### Preparation:

Heat Phase A and B separately to about 80° C. Stir Phase B into Phase A with homogenization, briefly after-homogenize. Cool to about 40° C., add Phase C, homogenize again.

### Example S12

### Face Tonic for Dry and Sensitive Skin

Phase A

| | |
|---|---|
| 2.50 | Hydrogenated castor oil PEG-40 |
| q.s. | Perfume oil |
| 0.40 | Bisabolol |

Phase B

| | |
|---|---|
| 3.00 | Glycerol |
| 1.00 | Hydroxyethylcetyldimonium phosphate |
| 5.00 | Witch hazel (Hamamelis Virginiana) distillate |
| 0.50 | Panthenol |
| 0.50 | Mixture 1 or mixture 2 |
| q.s. | Preservative |
| 87.60 | Dist. water |

### Preparation:

Dissolve Phase A to give a clear solution. Stir Phase B into Phase A.

### Example S13

### Peeling Cream, O/W Type

Phase A

| | |
|---|---|
| 3.00 | Ceteareth-6 |
| 1.50 | Ceteareth-25 |
| 3.00 | Glyceryl stearate |
| 5.00 | Cetearyl alcohol, sodium cetearyl sulfate |
| 6.00 | Cetearyl octanoate |
| 6.00 | Mineral oil |
| 0.20 | Bisabolol |

Phase B

| | |
|---|---|
| 2.00 | Propylene glycol |
| 0.10 | Disodium EDTA |
| 3.00 | Mixture 1 or mixture 2 |
| q.s. | Preservative |
| 59.70 | Dist. water |

Phase C

| | |
|---|---|
| 0.50 | Tocopheryl acetate |
| q.s. | Perfume oil |

Phase D

| | |
|---|---|
| 10.00 | Polyethylene |

### Preparation:

Heat Phases A and B separately to about 80° C. Stir Phase B into Phase A and homogenize. Cool to about 40° C., add Phase C and briefly homogenize again. Then stir in Phase D.

### Example S14

### Shaving Foam

| | |
|---|---|
| 6.00 | Ceteareth-25 |
| 5.00 | Poloxamer 407 |
| 52.00 | Dist. water |
| 1.00 | Triethanolamine |
| 5.00 | Propylene glycol |
| 1.00 | Lanolin oil PEG-75 |
| 5.00 | Mixture 1 or mixture 2 |
| q.s. | Preservative |
| q.s. | Perfume oil |
| 25.00 | Sodium laureth sulfate |

### Preparation:

Weigh everything together, then stir until dissolved. Bottling: 90 parts of active substance and 10 parts of 25:75 propane/butane mixture.

### Example S15

### Aftershave Balsam

Phase A

| | |
|---|---|
| 0.25 | Acrylate/C₁₀₋₃₀ alkyl acrylate copolymer |
| 1.50 | Tocopheryl acetate |
| 0.20 | Bisabolol |
| 10.00 | Caprylic/capric triglyceride |
| q.s. | Perfume oil |
| 1.00 | Hydrogenated castor oil PEG-40 |

Phase B

| | |
|---|---|
| 1.00 | Panthenol |
| 15.00 | Alcohol |
| 5.00 | Glycerol |
| 0.05 | Hydroxyethylcellulose |
| 1.92 | Mixture 1 or mixture 2 |
| 64.00 | Dist. water |

Phase C

| | |
|---|---|
| 0.08 | Sodium hydroxide |

### Preparation:

Mix the components of Phase A. Stir Phase B into Phase A with homogenization, briefly after-homogenize. Neutralize with Phase C and homogenize again.

### Example O16

### Toothpaste

Phase A

| | |
|---|---|
| 34.79 | Dist. water |
| 3.00 | Mixture 1 or mixture 2 |
| 0.30 | Preservative |
| 20.00 | Glycerol |
| 0.76 | Sodium monofluorophospate |

Phase B

| | |
|---|---|
| 1.20 | Sodium carboxymethylcellulose |

Phase C

| | |
|---|---|
| 0.80 | Aroma oil |
| 0.06 | Saccharin |
| 0.10 | Preservative |
| 0.05 | Bisabolol |
| 1.00 | Panthenol |
| 0.50 | Tocopheryl acetate |
| 2.80 | Silicon dioxide |
| 1.00 | Sodium lauryl sulfate |
| 7.90 | Dicalcium phosphate, anhydrous |
| 25.29 | Dicalcium phosphate dihydrate |
| 0.45 | Titanium dioxide |

### Preparation:

Dissolve Phase A. Scatter Phase B into Phase A and dissolve. Add Phase C and leave to stir at RT under a reduced pressure for about 45 min.

### Example O17

### Mouthwash

Phase A

| | |
|---|---|
| 2.00 | Aroma oil |
| 4.00 | Hydrogenated castor oil PEG-40 |
| 1.00 | Bisabolol |
| 30.00 | Alcohol |

Phase B

| | |
|---|---|
| 0.20 | Saccharin |
| 5.00 | Glycerol |
| q.s. | Preservative |
| 5.00 | Poloxamer 407 |
| 2.5 | Mixture 1 or Mixture 2 |
| 50.30 | Dist. water |

### Preparation:

Dissolve Phase A and Phase B separately to give a clear solution. Stir Phase B into Phase A.

### Example O18

### Denture Adhesive

Phase A

| | |
|---|---|
| 0.20 | Bisabolol |
| 1.00 | Betacarotene |
| q.s. | Aroma oil |
| 20.00 | Cetearyl octanoate |
| 5.00 | Silicon dioxide |
| 33.80 | Mineral oil |

Phase B

| | |
|---|---|
| 5.00 | Mixture 1 or Mixture 2 |
| 35.00 | PVP (20% strength solution in water) |

### Preparation:

Thoroughly mix Phase A. Stir Phase B into Phase A.

### Example O19

### Lipcare Cream

Phase A

| | |
|---|---|
| 10.00 | Cetearyl octanoate |
| 5.00 | Polybutene |

Phase B

| | |
|---|---|
| 0.10 | Carbomer |

Phase C

| | |
|---|---|
| 2.00 | Ceteareth-6 |
| 2.00 | Ceteareth-25 |
| 2.00 | Glyceryl stearate |
| 2.00 | Cetyl alcohol |
| 1.00 | Dimethicone |
| 1.00 | Benzophenone-3 |
| 0.20 | Bisabolol |
| 6.00 | Mineral oil |

Phase D

| | |
|---|---|
| 8.00 | Mixture 1 or Mixture 2 |
| 3.00 | Panthenol |
| 3.00 | Propylene glycol |
| q.s. | Preservative |
| 54.00 | Dist. water |

Phase E

| | |
|---|---|
| 0.10 | Triethanolamine |

Phase F

| | |
|---|---|
| 0.50 | Tocopheryl acetate |
| 0.10 | Tocopherol |
| q.s. | Perfume oil |

### Preparation:

Dissolve Phase A to give a clear solution. Add Phase B and homogenize. Add Phase C and melt at 80° C. Heat Phase D to 80° C. Add Phase D to Phase ABC and homogenize. Cool to about 40° C., add Phase E and Phase F, homogenize again.

### Example S20

### Freshening Gel

A

| | |
|---|---|
| 0.60 | Carbomer |
| 45.40 | Dist. water |

B

| | |
|---|---|
| 0.50 | Bisabolol |
| 0.50 | Farnesol |
| q.s. | Perfume oil |
| 5.00 | PEG-40 hydrogenated castor oil |
| 2.50 | Mixture 1 or Mixture 2 |
| 1.00 | Tetrahydroxypropylethylenediamine |
| 1.50 | Menthol |
| 43.00 | Alcohol |
| q.s. | C.I. 74 180, Direct Blue 86 |

### Preparation:

Allow Phase A to swell. Dissolve Phase B. Stir Phase B into Phase A.

### Example S21

### Roll-on Antiperspirant

A

| | |
|---|---|
| 0.40 | Hydroxyethylcellulose |
| 50.00 | Dist. water |

B

| | |
|---|---|
| 25.00 | Alcohol |
| 0.10 | Bisabolol |
| 0.30 | Farnesol |
| 2.00 | PEG-40 hydrogenated castor oil |
| q.s. | Perfume oil |

C

| | |
|---|---|
| 5.00 | Aluminum chlorohydrate |
| 3.00 | Propylene glycol |
| 3.00 | Dimethicone copolyol |
| 3.00 | Polyquaternium-16 |
| 6.00 | Mixture 1 or Mixture 2 |
| 2.20 | Dist. water |

### Preparation:

Allow Phase A to swell. Dissolve Phase B and Phase C separately. Stir Phase A and B into Phase C.

### Example S22

### Transparent Deodorant Stick

| | |
|---|---|
| 5.00 | Sodium stearate |
| 0.50 | Triclosan |
| 3.00 | Ceteareth-25 |
| 20.00 | Glycerol |
| 2.50 | Mixture 1 or Mixture 2 |
| q.s. | Perfume oil |
| 60.00 | Propylene glycol |
| 0.20 | Bisabolol |
| 10.80 | Dist. water |

### Preparation:

Weigh Phase A together, melt and homogenize. Then pour into the mold.

### Example S23

### Daycare Aerosol

A

| | |
|---|---|
| 4.00 | Ethylhexyl methoxycinnamate |
| 1.50 | Octocrylene |
| 9.00 | Caprylic/capric triglyceride |
| 5.00 | Simmondsia Chinensis (jojoba) seed oil |
| 1.50 | Cyclomethicone |
| 3.00 | Hydrogenated coco glycerides |
| 1.00 | PVP/hexadecene copolymer |
| 1.00 | Ceteareth-6, stearyl alcohol |

B

| | |
|---|---|
| 5.00 | Zinc oxide |

C

| | |
|---|---|
| 2.00 | Ceteareth-25 |
| 1.20 | Panthenol |
| 0.20 | Sodium ascorbyl phosphate |
| 0.30 | Imidazolidinylurea |
| 0.10 | Disodium EDTA |
| 7.50 | Mixture 1 or Mixture 2 |
| 56.67 | Dist. water |

D

| | |
|---|---|
| 0.50 | Tocopheryl acetate |
| 0.20 | Bisabolol |
| 0.33 | Caprylic/capric triglyceride, retinol |
| q.s. | Perfume oil |

### Preparation:

Heat Phase A to 80° C. Dissolve Phase A to give a clear solution. Incorporate Phase B and homogenize. Add Phase C, heat to 80° C., melt and homogenize. Cool to about 40° C. with stirring, add Phase D and briefly homogenize. Bottle 90% active ingredient solution: 10% propane/butane with 3.5 bar (20° C.).

### Example H24

### Pump Mousse

A

| | |
|---|---|
| 2.00 | Cocotrimonium methosulfate |
| q.s. | Perfume oil |

C

| | |
|---|---|
| 84.30 | Dist. water |
| 7.00 | Polyquaternium-46 (10% strength aqueous solution) |
| 5.00 | Mixture 1 or Mixture 2 |
| 0.50 | PEG-8 |
| 1.00 | Panthenol |
| q.s. | Preservative |
| 0.20 | PEG-25 PABA (ethoxylated p-aminobenzoic acid) |

### Preparation:

Mix the components of Phase A. Add the components of Phase B one after the other and dissolve to give a clear solution.

### Example H25

### Aerosol Foam

| | |
|---|---|
| 15.00 | Mixture 1 or Mixture 2 |
| 5.00 | PVP/VA copolymer (40% strength aqueous solution) |
| 0.50 | Hydroxyethylcetyldimonium phosphate |
| 0.20 | Ceteareth-25 |
| 0.40 | Perfume oil PC 910.781/Cremophor |
| 68.90 | Dist. water |
| q.s. | Preservative |
| 10.00 | Propane/butane 3.5 bar (20° C.) |

### Preparation:

Weigh everything together, stir until dissolved, then bottle.

### Example H26

### Color Styling Mousse

A

| | |
|---|---|
| 2.00 | Cocotrimonium methosulfate |
| q.s. | Perfume oil |

B

| | |
|---|---|
| 23.50 | Mixture 1 or Mixture 2 |
| 0.50 | Acrylate copolymer (Luvimer ® 100 P, BASF) |
| 0.10 | Aminomethylpropanol |
| 0.20 | Ceteareth-25 |
| 0.20 | Panthenol |
| 0.20 | Hydroxyethylcellulose |
| 10.00 | Alcohol |
| 53.17 | Dist. water |
| 0.08 | C.I. 12245, Basic Red 76 |
| 0.05 | C.I. 42510, Basic Violet 14 |

C

| | |
|---|---|
| 10.00 | Propane/butane 3.5 bar (20° C.) |

### Preparation:

Weigh everything together, stir until dissolved, then bottle. Only suitable for dark blond and brown hair!

### Example H27

### Dark Brown Permanent Hair Color (Oxidation Hair Color)

A

| | |
|---|---|
| 46.90 | Dist. water |
| 0.20 | Sodium sulfite |
| 0.05 | Disodium EDTA |
| 0.20 | p-Phenylenediamine |
| 0.30 | Resorcinol |
| 0.20 | 4-Amino-2-hydroxytoluene |
| 0.10 | m-Aminophenol |
| 1.50 | Oleyl alcohol |
| 4.50 | Propylene glycol |
| 2.30 | Sodium C₁₂₋₁₅ pareth-15 sulfonate |
| 20.00 | Oleic acid |

B

| | |
|---|---|
| 5.00 | Mixture 1 or Mixture 2 |
| 13.70 | Ammonium hydroxide |
| 6.00 | i-Propanol |
| q.s. | Perfume |

### Preparation:

Solubilize Phase A. Add the components of Phase B one after the other and mix.

### Example H28

### Light Brown Semipermanent Hair Color

| | |
|---|---|
| 10.00 | Cocodiethanolamide |
| 4.00 | Sodium dodecylbenzylsulfonate, 50% strength |
| 5.00 | Mixture 1 or Mixture 2 |
| 6.00 | C₉₋₁₁ Pareth-3 |
| 2.50 | Sodium lauryl sulfate |
| 0.40 | 2-Nitro-p-phenylenediamine |
| 0.20 | HC Red No. 3 |
| 0.20 | HC Yellow No. 2 |
| 71.70 | Dist. water |

### Preparation:

Add the components one after the other and mix

### Example H29

### Setting Solution

| | [%] |
|---|---|
| Mixture 1 or Mixture 2 | 18.00 |
| Ethanol | 82.00 |

Further additive: silicone, perfume, antifoam . . .

1. A process for producing antistatically treated, expandable styrene polymers, which comprises admixing a styrene polymer melt with from 0.05 to 6% by weight of an antistatic and a blowing agent, extruding it through a die and pelletizing it.

2. The process according to claim 1, wherein the styrene polymer melt is admixed with from 0.1 to 4% by weight of an antistatic.

3. The process according to claim 1, wherein a quaternary ammonium salt is used as antistatic.

4. The process according to claim 1, wherein the alkali metal salt of a C₁₂-C₂₀-alkane sulfonate is used.

5. The process according to claim 1, wherein a coating comprising an antistatic is additionally applied to the pellets after pelletization.

6. An antistatically treated, expandable styrene polymer obtainable according claim 1.

7. The process according to claim 2, wherein a quaternary ammonium salt is used as antistatic.

8. The process according to claim 2, wherein the alkali metal salt of a C₁₂-C₂₀-alkane sulfonate is used.

9. The process according to claim 2, wherein a coating comprising an antistatic is additionally applied to the pellets after pelletization.

10. An antistatically treated, expandable styrene polymer obtainable according claim 2.

11. The process according to claim 3, wherein a coating comprising an antistatic is additionally applied to the pellets after pelletization.

12. An antistatically treated, expandable styrene polymer obtainable according claim 3.

13. The process according to claim 4, wherein a coating comprising an antistatic is additionally applied to the pellets after pelletization.

14. An antistatically treated, expandable styrene polymer obtainable according claim 4.
